(19) United States
(12) Patent Application Publication
(10) Pub. No.: US 2011/0118127 A1
(43) Pub. Date: May 19, 2011

(54) MARKER GENES FOR SCREENING OF DRUG-INDUCED TOXICITY IN HUMAN CELLS AND SCREENING METHOD USING THE SAME

(75) Inventors: Jae-Chun RYU, Seoul (KR); Youn Jung KIM, Seoul (KR); Mee SONG, Seoul (KR); Mi-Kyung SONG, Ulsan-si (KR); Han Seam CHOI, Cheonan-si (KR); Ji Hee KIM, Busan-si (KR); Jina LEE, Seoul (KR)

(73) Assignee: KOREA INSTITUTE OF SCIENCE AND TECHNOLOGY, Seoul (KR)

(21) Appl. No.: 12/720,134

(22) Filed: Mar. 9, 2010

(30) Foreign Application Priority Data
Nov. 16, 2009 (KR) 10-2009-0110205

(51) Int. Cl. C40B 30/00; C40B 40/08

(52) U.S. Cl. 506/7; 506/17

(57) ABSTRACT

The present invention relates to a marker gene for screening a drug inducing toxicity in human and a screening method using the same. More precisely, the invention relates to a microarray on which marker genes up-or down-regulated specifically by 16 drugs inducing pulmonary toxicity, teratogenicity, nephrotoxicity, cardiotoxicity or mutation (Methotrexate, Nitrofurantoin, Amiodarone, Carbamazepine, Valproic acid, Thalidomide, Cisplatin, Gentamycin, Amphotericine, Furylfuramide, N-nitroso-N-methylurea, methylmethanesulfonate, 4-nitroquinoline-N-oxide, 2-nitrofluorene, Doxorubicin and Daunorubicin) are integrated, a kit comprising the said microarray, and a screening method of a drug inducing toxicity in human using the same. The DNA microarray containing the marker gene of the present invention facilitates the construction of Toxtarget Array for screening a drug inducing toxicity in human using drug-specific genes, suggesting that this chip can be effectively used for monitoring drugs or chemicals carrying toxicity to human or determining risks thereof and also it can be used as a tool for examining mechanisms of toxicity/side effects caused by the drugs.

### CROSS-REFERENCES TO RELATED APPLICATION

This patent application claims the benefit of priority from Korean Patent Application No. 10-2009-0110205, filed on Nov. 16, 2009, the contents of which are incorporated herein by reference.

### BACKGROUND OF THE INVENTION

1. Field of the Invention

The present invention relates to a marker gene for screening a drug inducing toxicity in human cells and a screening method using the same, more precisely a marker gene which is up- or down-regulated by a drug inducing pulmonary toxicity, teratogenicity, nephyrotoxicity, cardiotoxicity or mutation in human cells and a screening method by Toxtarget Array using the same.

2. Description of the Related Art

Approximately 100,000 kinds of chemicals have been developed world-widely so far, and actually more than 10,000 chemicals of them have been commercialized. Therefore, it is necessary to control those chemicals systematically and to study on risks at a large scale. Thus, it is also required to establish techniques and methods for monitoring and predication of toxicity of chemicals based on toxicogenomic study.

The conventional, classical toxicity evaluation technique that has been used tens of years is so-called the process testing safety of novel drug candidates, suggesting that it requires long-term test period, high costs, highly experienced labors and numbers of test animals, with raising dispute on the matter of difference among each test subject. Moreover, recently animal protection groups advocate strongly the rights and interests of animals, which restrains the study using animals. So, a new test method using less animals or alternatives is required. Considering the amount of new matters newly produced, it is very difficult to test them all with the conventional toxicity evaluation method. So, a novel test method of toxicity that is simple and fast is requested.

According to the rush of new paradigm in the development of novel drugs along with rapid advance of functional genomics, it is now realized to identify a drug target efficiently and to screen a promising candidate in a short period of time. To do so, it is necessary to test pharmacological effects of drug and evaluate the safety of drug accurately and fast. Therefore, it is prerequisite to introduce new paradigm into the development of novel drugs, for example research system for the study of effect of drug, absorption, distribution, metabolism, and excretion (ADME) using pharmacogenomics; systems for prediction and evaluation of toxicity using toxicogenomics; and screening method of target drugs using animal disease models. Toxicogenomic techniques are absolutely required to analyze toxicity-caused risks in human and for early decision making in the middle of the drug development, based on which high throughput screening of target drug toxicity can be realized. Therefore, it can be said that the method using toxicogenetic techniques based on DNA microarray is the best and only alternative that can overcome problems of the conventional toxicity evaluation method.

Genome sequencing projects including 6 species of mammals and 292 species of microorganisms have been completed and reported to NCBI (National Center for Biotechnology Information). Based on the huge amount of data obtained thereby, genome-wide expression study has been performed to disclose functions of genes. To analyze expressions of thousands of genes at a time, DNA microarray is performed (Schena, M., et al., Proc. Natl. Acad. Sci. USA 93: 10614-10619, 1996).

Microarray is prepared by integrating cDNA (complementary DNA) or 20-25 base pair-long oligonucleotide sets on a glass. cDNA microarray is now produced in school labs or companies such as Agilent or Genomic Solutions by fixing mechanically or ink-jetting the cDNA collections on a chip (Sellheyer, K and Belbin, T. J., J. Am. Acad. Dermatol. 51: 681-692, 2004). Oligonucleotide microarray is produced by direct synthesis on a chip using photolithography by Affymetrix, or produced by fixing synthetic oligonucleotides on a chip by Agillent (Sellheyer, K. et. al., Am. Acad. Dermatol. 51: 681-692, 2004).

To analyze gene expression, RNA is first extracted from samples such as tissues, followed by hybridization with oligonucleotides on DNA microarray. The obtained RNA is labeled with fluorescence or isotope, which is then converted into cDNA. When oligonucleotide microarray is used, two different fluorescences (ex: Cy3 and Cy5) are used to label the control group and the experimental group respectively, and then hybridization is performed simultaneously on one chip, followed by optical image scanning. Then, fluorescent intensity is measured, followed by analysis. Gene expression is evaluated by comparing those two different fluorescent intensities (Somasundaram, K., et al., Genomics Proteomics I: 1-10, 2002).

With the aid of the most advanced techniques of toxicogenomics using DNA microarray, it is now possible to perform high throughput analysis of gene expression patterns and quantification of gene expressions in specific tissue or cell line triggered by drugs, novel drug candidates or any other chemicals. Accordingly, it is also possible to screen a gene involved in drug side-effect by analyzing a specific gene expression in a specific target cell, leading to understanding of molecular mechanism in relation to drug functions and side effects and further to the screening and diagnosis of a material causing toxicity and side effects.

The present inventors observed and analyzed gene expression profiles in human cells affected by a drug causing toxicity (pulmonary toxicity, teratogenicity, nephrotoxicity, cardio toxicity or mutation). Thereafter, the inventors identified those genes up- or down-regulated by the drug and then established the screening method of a drug causing toxicity in human cells using marker genes facilitating detection of a drug causing toxicity in human cells and Toxtarget Array prepared therefrom, leading to the completion of this invention.

### SUMMARY OF THE INVENTION

It is an object of the present invention to provide Toxtarget Array using drug-specific genes up- or down-regulated by the drug causing toxicity including pulmonary toxicity, teratogenicity, nephrotoxicity, cardio toxicity, mutation or general toxicity, and the screening method of a drug causing toxicity in human using the same.

To achieve the above object, the present invention provides a DNA microarray for the screening of drugs causing toxicity in human, on which oligonucleotides, which are fragments of the gene up- or down-regulated by the drug causing toxicity including pulmonary toxicity, teratogenicity, nephrotoxicity, cardio toxicity, mutation or general toxicity, composed of the full length or 18-30 nucleic acids of each gene or their complementary sequences are integrated.

The present invention also provides a screening method of a drug causing toxicity in human using the said DNA microarray.

The present invention further provides a kit for screening a drug causing toxicity in human containing the said DNA microarray.

### Advantageous Effect

According to the present invention, those genes specifically up- or down-regulated by the drug causing toxicity such as pulmonary toxicity, teratogenicity, nephrotoxicity, cardio toxicity, mutation or general toxicity are selected and grouped. The genes can be selected from each group and integrated on one chip, which is then treated with a specific compound to detect changes of gene expression patterns. Once a gene showing changes in its expression is identified, it can be judged what kind of toxicity is induced by which compound. On the other hand, according to the prior art, sample is treated to gene and then the expression of the gene is observed to screen sample-specific toxicity. In that case, the gene expression can also be changed by the treatment of any other drugs inducing different toxicity. Therefore, the conventional method has limitation in judging which drug induces what toxicity simply by detecting changes in gene expression pattern. And the present invention proudly overcomes such limitation of the prior art.

### BRIEF DESCRIPTION OF THE DRAWINGS

The application of the preferred embodiments of the present invention is best understood with reference to the accompanying drawings, wherein:

FIG. 1 is a schematic diagram of Toxtarget Array.

FIG. 2 is a diagram showing the sample product of Toxtarget Array.

FIG. 3 is a diagram showing the results of hierarchical clustering image analysis and principal component analysis performed to distinguish different toxicity identified by Toxtarget Array.

### DESCRIPTION OF THE PREFERRED EMBODIMENTS

Hereinafter, the present invention is described in detail.

The present invention provides a DNA microarray chip for the screening of a drug causing toxicity in human, on which genes whose expressions are changed specifically by the drug causing pulmonary toxicity, teratogenicity, nephrotoxicity, cardio toxicity, mutation or general toxicity or their fragments or their complementary sequences are integrated.

The DNA microarray of the present invention is constructed by the processes of selecting and grouping genes whose expressions are changed specifically by the drug causing pulmonary toxicity, teratogenicity, nephrotoxicity, cardio toxicity, mutation or general toxicity; and integrating one or more genes selected from each group (that is, at least 6 genes are included because at least one gene is selected from each group) on one chip.

The prior art is to screen toxicity induced by sample by using the gene showing changes in expression pattern by the treatment of a specific toxicity inducing material. According to this conventional method, the gene expression pattern can also be changed by another drug causing different toxicity. So, it is hard to tell that the gene is specific to which drug, that is even if the gene expression pattern is changed by a drug, it is difficult to judge toxicity induced therein is induced by that drug. On the other hand, according to the present invention, genes whose expressions are changed specifically by the drug causing toxicity are integrated on one chip. Therefore, when a specific compound is treated to the chip, and a change in gene expression is detected and then it can be screened which toxicity is induced by the compound.

The microarray of the present invention is preferably constructed by integrating oligonucleotides composed of the full length or 18-30 nucleic acids of the gene selected from the below group 1-group 6 or their complementary sequences on a chip, but not always limited thereto:

Group 1) one or more genes selected from the following gene group showing changes in expression specifically by the treatment of a drug causing pulmonary toxicity:

GenBank AF289615 (hypothetical protein), GenBank NM_{—}000575 (interleukin 1, alpha), GenBank NM_{—}001001958 (olfactory receptor, family 7, subfamily g, member 3), GenBank NM_{—}001295 [chemokine(c-c motif) receptor 1], GenBank NM_{—}002305 [lectin, galactoside-binding, soluble, 1 (galectin 1)], GenBank NM_{—}004293 (guanine deaminase), GenBank NM_{—}030754 (serum amyloid a2);

Group 2) one or more genes selected from the following gene group showing changes in expression specifically by the treatment of a drug causing teratogenicity:

GenBank NM_{—}000735 (glycoprotein hormones, alpha polypeptide), GenBank NM_{—}004155 [serpin peptidase inhibitor, clade b (ovalbumin), member 9], GenBank NM_{—}005668 (st8 alpha-n-acetyl-neuraminide alpha-2,8-sialyltransferase 4), GenBank NM_{—}032484 (homolog of mouse lgp1);

Group 3) one or more genes selected from the following gene group showing changes in expression specifically by the treatment of a drug causing nephrotoxicity:

GenBank NM_{—}000134 (fatty acid binding protein 2, intestinal), GenBank NM_{—}005203 (collagen, type xiii, alpha 1), GenBank NM_{—}015946 (pro1770 protein), GenBank NM_{—}138417 [kti12 homolog, chromatin associated (s. cerevisiae)], GenBank NM_{—}145202 (proline-rich acidic protein 1), GenBank NM_{—}173160 (fxyd domain containing ion transport regulator 4);

Group 4) one or more genes selected from the following gene group showing changes in expression specifically by the treatment of a drug causing mutation:

GenBank NM_{—}000715 (complement component 4 binding protein, alpha), GenBank NM_{—}001141 (arachidonate 15-lipoxygenase, type b), GenBank NM_{—}001711 (biglycan), GenBank NM_{—}001974 (egf-like module containing, mucin-like, hormone receptor-like 1), GenBank NM_{—}003722 (tumor protein p73-like), GenBank NM_{—}005510 [dom-3 homolog z (c. elegans)], GenBank NM_{—}007267 (transmembrane channel-like 6);

Group 5) one or more genes selected from the following gene group showing changes in expression specifically by the treatment of a drug causing cardiotoxicity:

GenBank NM_{—}012415 (fibrinogen silencer binding protein), GenBank NM_{—}021101 (claudin 1); and

Group 6) one or more genes selected from the following gene group showing changes in expression specifically by the treatment of a drug causing general toxicity:

GenBank NM_{—}000051 [ataxia telangiectasia mutated (includes complementation groups a, c and d)], GenBank NM_{—}000104 (cytochrome p450, family 1, subfamily b, polypeptide 1), GenBank NM_{—}000120 [epoxide hydrolase 1, microsomal (xenobiotic)], GenBank NM_{—}000240 (monoamine oxidase a), GenBank NM_{—}000546 [tumor protein p53 (li-fraumeni syndrome)], GenBank NM_{—}000639 [fas ligand (tnf superfamily, member 6)], GenBank NM_{—}000762 (cytochrome p450, family 2, subfamily a, polypeptide 6), GenBank NM_{—}000771 (cytochrome p450, family 2, subfamily c, polypeptide 9), GenBank NM_{—}000773 (cytochrome p450, family 2, subfamily e, polypeptide 1), GenBank NM_{—}000780 (cytochrome p450, family 7, subfamily a, polypeptide 1), GenBank NM_{—}000847 (glutathione s-transferase a3), GenBank NM_{—}000851 (glutathione s-transferase m5), GenBank NM_{—}000927 [atp-binding cassette, sub-family b (mdr/tap), member 1], GenBank NM_{—}000940 (paraoxonase 3), GenBank NM_{—}000962 [prostaglandin-endoperoxide synthase 1 (prostaglandin g/h synthase and cyclooxygenase)], GenBank NM_{—}001540 (heat shock 27 kda protein 1), GenBank NM_{—}001565 [chemokine (c-x-c motif) ligand 10], GenBank NM_{—}001746 (calnexin), GenBank NM_{—}001752 (catalase), GenBank NM_{—}001885 (crystallin, alpha b), GenBank NM_{—}001979 (epoxide hydrolase 2, cytoplasmic), GenBank NM_{—}002021 (flavin containing monooxygenase 1), GenBank NM_{—}002083 [glutathione peroxidase 2 (gastrointestinal)], GenBank NM_{—}002155 [heat shock 70 kda protein 6 (hsp70b′)], GenBank NM_{—}003167 [sulfotransferase family, cytosolic, 2a, dehydroepiandrosterone(dhea)-preferring, member 1], GenBank NM_{—}003786 [atp-binding cassette, sub-family c (cftr/mrp), member 3], GenBank NM_{—}003932 [suppression of tumorigenicity 13 (colon carcinoma) (hsp70 interacting protein)], GenBank NM_{—}004050 (bcl2-like 2), GenBank NM_{—}004083 (dna-damage-inducible transcript 3), GenBank NM_{—}004323 (bcl2-associated athanogene), GenBank NM_{—}004343 (calreticulin), GenBank NM_{—}004605 (sulfotransferase family, cytosolic, 2b, member 1), GenBank NM_{—}004820 (cytochrome p450, family 7, subfamily b, polypeptide 1), GenBank NM_{—}004832 (glutathione s-transferase omega 1), GenBank NM_{—}005420 (sulfotransferase family 1e, estrogen-preferring, member 1), GenBank NM_{—}005431 (x-ray repair complementing defective repair in Chinese hamster cells 2), GenBank NM_{—}005953 (metallothionein 2a), GenBank NM_{—}006308 (heat shock 27 kda protein 3), GenBank NM_{—}006431 [chaperonin containing tcp1, subunit 2 (beta)], GenBank NM_{—}006588 (sulfotransferase family, cytosolic, 1c, member 2), GenBank NM_{—}007326 (cytochrome b5 reductase 3), GenBank NM_{—}012266 [dnaj (hsp40) homolog, subfamily b, member 5], GenBank NM_{—}014280 [dnaj (hsp40) homolog, subfamily c, member 8], GenBank NM_{—}016100 [n-acetyltransferase 5 (ard1 homolog, s. cerevisiae)], GenBank NM_{—}017460 [cytochrome p450, subfamily iiia (niphedipine oxidase), polypeptide 3], GenBank NM_{—}018602 [dnaj (hsp40) homolog, subfamily a, member 4], GenBank NM_{—}021979 (heat shock 70 kda protein 2), GenBank NM_{—}033292 [caspase 1, apoptosis-related cysteine peptidase (interleukin 1, beta, convertase)], GenBank NM_{—}053056 (cyclin d1).

The said drug causing pulmonary toxicity is preferably Methotrexate, Nitrofurantoin, Amiodarone or Carbamazepine, the said drug causing teratogenicity is preferably Valproic acid, Thalidomide or Methotrexate, the said drug causing nephrotoxicity is preferably Cisplatin, Gentamycin or Amphotericine, the said drug causing mutation is preferably Furylfuramide (AF-2), N-nitroso-N-methylurea (MNU), methylmethanesulfonate (MMS), 4-nitroquinoline-N-oxide (4-NQO) or 2-nitrofluorene (2NF), and the said drug causing cardiotoxicity is preferably Doxorubicin or Daunorubicin, but not always limited thereto.

In this invention, marker genes showing changes in expression by a drug causing toxicity in human were selected as follows:

GenBank A_{—}24_P349756, GenBank AA995107 (interleukin 7 receptor), GenBank AB044088 (basic helix-loop-helix domain containing, class b, 3), GenBank AB195679 (hypothetical protein flj20366), GenBank AF289615 (hypothetical protein), GenBank AK024898, GenBank AK027210 (dual specificity phosphatase 14), GenBank AK095849 (major histocompatibility complex, class i, a), GenBank AK098095 (v-raf murine sarcoma viral oncogene homolog b1), GenBank AK124635 (proprotein convertase subtilisin/kexin type 9), GenBank AK125636 [glutaredoxin (thioltransferase)], GenBank AK127679 (dual specificity phosphatase 1), GenBank AK131071 [solute carrier family 31 (copper transporters), member 2], GenBank AL832142 (g protein-coupled receptor 137b), GenBank AL832445 (hypothetical protein flj25770), GenBank AY247738 [tribbles homolog 3 (drosophila)], GenBank AY367065 (hypothetical protein flj10517), GenBank BC008678 (interleukin 1, beta), GenBank BC021552 (calcium channel, voltage-dependent, gamma subunit 6), GenBank BO031405 (dual specificity phosphatase 10), GenBank BC043371 [growth factor independent 1b (potential regulator of cdkn1a, translocated in cml)], GenBank BC052951 (lamin b1), GenBank BC053653 [chemokine (c-x-c motif) ligand 2], GenBank BC065304 (dep domain containing 1), GenBank BC065544 (putative protein p243 which interacts with transcription factor sp1), GenBank BC069137 [interleukin 5 (colony-stimulating factor, eosinophil)], GenBank BE300829, GenBank BG564326 (serum amyloid a4, constitutive), GenBank BG564669 (serum amyloid a1), GenBank BM906235 (inhibitor of dna binding 3, dominant negative helix-loop-helix protein), GenBank BM918324 (lymphocyte antigen 96), GenBank BU845177 [ras-related c3 botulinum toxin substrate 1 (rho family, small gtp binding protein rac1)], GenBank BX648583 (egf-like repeats and discoidin i-like domains 3), GenBank CR614015 (cd14 antigen), GenBank CR618407 (bone morphogenetic protein 2), GenBank CR936799 (four and a half lim domains 2), GenBank D26122 (splicing factor 1), GenBank D63880 (chromosome condensation-related smc-associated protein 1), GenBank M92424 [mdm2, transformed 3t3 cell double minute 2, p53 binding protein (mouse)], GenBank NM_{—}000189 (hexokinase 2), GenBank NM_{—}000575 (interleukin 1, alpha), GenBank NM_{—}000600 [interleukin 6 (interferon, beta 2)], GenBank NM_{—}000641 (interleukin 11), GenBank NM_{—}000944 [protein phosphatase 3 (formerly 2b), catalytic subunit, alpha isoform (calcineurin a alpha)], GenBank NM_{—}001001958 (olfactory receptor, family 7, subfamily g, member 3), GenBank NM_{—}001025077 (cug triplet repeat, rna binding protein 2), GenBank NM_{—}001295 [chemokine (c-c motif) receptor 1], GenBank NM_{—}001733 (complement component 1, r subcomponent), GenBank NM_{—}001734 (complement component 1, s subcomponent), GenBank NM_{—}002260 (killer cell lectin-like receptor subfamily c, member 2), GenBank NM_{—}002305 [lectin, galactoside-binding, soluble, 1 (galectin 1)], GenBank NM_{—}003629 [phosphoinositide-3-kinase, regulatory subunit 3 (p55, gamma)], GenBank NM_{—}003955 (suppressor of cytokine signaling 3), GenBank NM_{—}004265 (fatty acid desaturase 2), GenBank NM_{—}004293 (guanine deaminase), GenBank NM_{—}004759 (mitogen-activated protein kinase-activated protein kinase 2), GenBank NM_{—}004864 (growth differentiation factor 15), GenBank NM_{—}006464 (trans-golgi network protein 2), GenBank NM_{—}007371 (bromodomain containing 3), GenBank NM_{—}012338 (tetraspanin 12), GenBank NM_{—}013372 [gremlin 1, cysteine knot superfamily, homolog (xenopus laevis)], GenBank NM_{—}014391 [ankyrin repeat domain 1 (cardiac muscle)], GenBank NM_{—}014707 (histone deacetylase 9), GenBank NM_{—}022726 [elongation of very long chain fatty acids (fen1/elo2, sur4/elo3, yeast)-like 4], GenBank NM_{—}030754 (serum amyloid a2), GenBank NM_{—}134470 (interleukin 1 receptor accessory protein), GenBank NM_{—}139314 (angiopoietin-like 4), GenBank NM_{—}172220 [colony stimulating factor 3 (granulocyte)], GenBank NM_{—}198187 (astrotactin 2), GenBank NM_{—}199511 (steroid sensitive gene 1), GenBank NM_{—}207035 (chromosome 1 open reading frame 63), GenBank U68019 [smad, mothers against dpp homolog 3 (drosophila)], GenBank X96753 [chondroitin sulfate proteoglycan 4 (melanoma-associated)], GenBank AB018258 (ATPase, class v, type 10b), GenBank AB209845 (transcription termination factor, rna polymerase ii variant), GenBank AF001893 (trophoblast-derived noncoding rna), GenBank AK001879 (hypothetical protein flj11017), GenBank AK023571 (zinc finger protein 100), GenBank AK023574 (zinc finger rna binding protein), GenBank AK057515, GenBank AK095632 [ankyrin repeat and btb (poz) domain containing 2], GenBank AK122757 [melanocortin 1 receptor (alpha melanocyte stimulating hormone receptor)], GenBank AK125877 (hypothetical protein mgc27016), GenBank AK126731 (islet cell autoantigen 1, 69 kda), GenBank BC036890 [grainyhead-like (drosophila)], GenBank BC042755 (regulator of g-protein signalling 2, 24 kda), GenBank BC063830 [st6 (alpha-n-acetyl-neuraminyl-2,3-beta-galactosyl-1,3)-n-acetylgalactosaminide alpha-2,6-sialyltransferase 1], GenBank BX111592, GenBank BX648021 (v-set domain containing t cell activation inhibitor 1), GenBank BX649112 (cobl-like 1), GenBank NM_{—}000735 (glycoprotein hormones, alpha polypeptide), GenBank NM_{—}001003793 (RNA binding motif, single stranded interacting protein), GenBank NM_{—}001618 [poly (adp-ribose) polymerase family, member 1], GenBank NM_{—}002356 (myristoylated alanine-rich protein kinase c substrate), GenBank NM_{—}004155 [serpin peptidase inhibitor, clade b (ovalbumin), member 9], GenBank NM_{—}004615 (tetraspanin 7), GenBank NM_{—}005668 (st8 alpha-n-acetyl-neuraminide alpha-2,8-sialyltransferase 4), GenBank NM_{—}018018 (solute carrier family 38, member 4), GenBank NM_{—}024342 (glucocorticoid receptor dna binding factor 1), GenBank NM_{—}032484 (homolog of mouse lgp1), GenBank NM_{—}181659 (nuclear receptor coactivator 3), GenBank XM_{—}031553 (u2-associated sr140 protein), GenBank Y18483 [solute carrier family 7 (cationic amino acid transporter, y+ system), member 8], GenBank AB018270 (myosin id), GenBank AB040955 (kiaa1522), GenBank AB075871 (hypothetical protein hmfn1187), GenBank AF097935 (desmoglein 1), GenBank AF279145 (tumor endothelial marker 8), GenBank AF307451 (cat eye syndrome chromosome region, candidate 6), GenBank AJ002535 (hypothetical protein flj14124), GenBank AK001361 [protein phosphatase 1, regulatory (inhibitor) subunit 15a], GenBank AK023662 (chromosome 9 open reading frame 44), GenBank AK024144 (hypothetical protein flj14082), GenBank AK025974 (hypothetical protein mgc2574), GenBank AK026909 (disrupter of silencing 10), GenBank AK074052 (tripartite motif-containing 41), GenBank AK094580 (serine/threonine kinase 32a), GenBank AK095253 (bystin-like), GenBank AK096265 (sushi domain containing 4), GenBank AK096289 (thrombospondin, type i, domain containing 1), GenBank AK122912 (lck interacting transmembrane adaptor 1), GenBank AL136662 (chromosome 15 open reading frame 44), GenBank AL833764 [fer-1-like (c. elegans)], GenBank AY008294 [zinc finger protein, subfamily 1a, 2 (helios)], GenBank AY129013 (tbc1 domain family, member 17), GenBank AY203954 [rna binding motif (rnp1, rrm) protein 3], GenBank AY358993 (keratinocyte associated protein 3), GenBank AY706204 [sin3 homolog b, transcription regulator (yeast)], GenBank BC004102 (aldehyde dehydrogenase 3 family, membera1), GenBank BC025741 (chromosome 16 open reading frame 54), GenBank BC033515 (lysm, putative peptidoglycan-binding, domain containing 2), GenBank BC040191 (solute carrier family 35, member e4), GenBank BC051890 (tubulin, gamma 2), GenBank BC067751 [v-maf musculoaponeurotic fibrosarcoma oncogene homolog f (avian)], GenBank BC073828 [protein phosphatase 1j (pp2c domain containing)], GenBank BE889572 (receptor transporter protein 4), GenBank BM542003 (wd repeat domain 54), GenBank BM555452 (tumor necrosis factor receptor superfamily, member 12a), GenBank BU673968 [rio kinase 3 (yeast)], GenBank BX537620 [3-hydroxy-3-methylglutaryl-coenzyme a synthase (soluble)], GenBank BX640959 (hypothetical protein flj14213), GenBank CR601067 (plasminogen activator, urokinase receptor), GenBank CR613579 (growth arrest and dna-damage-inducible, gamma), GenBank D67025 [proteasome (prosome, macropain) 26s subunit, non-atpase, 3], GenBank NM_{—}000134 (fatty acid binding protein 2, intestinal), GenBank NM_{—}001001524 (transmembrane 6 superfamily member 2), GenBank NM_{—}001004703 (olfactory receptor, family 4, subfamily c, member 46), GenBank NM_{—}001005190 (olfactory receptor, family 7, subfamily a, member 10), GenBank NM_{—}001010867 (chromosome 1 open reading frame 69), GenBank NM_{—}001215 (carbonic anhydrase vi), GenBank NM_{—}002409 [mannosyl(beta-1,4-)-glycoprotein beta-1,4-n-acetylglucosaminyltransferase], GenBank NM_{—}002918 [regulatory factor x, 1 (influences hla class ii expression)], GenBank NM_{—}005203 (collagen, type xiii, alpha 1), GenBank NM_{—}005247 [fibroblast growth factor 3 (murine mammary tumor virus integration site (v-int-2) oncogene homolog)], GenBank NM_{—}005310 (growth factor receptor-bound protein 7), GenBank NM_{—}012110 (cysteine-rich hydrophobic domain 2), GenBank NM_{—}014323 (zinc finger protein 278), GenBank NM_{—}015946 (pro1770 protein), GenBank NM_{—}020458 (tetratricopeptide repeat domain 7a), GenBank NM_{—}031298 (transmembrane protein 93), GenBank NM_{—}080542 [collagen-like tail subunit (single strand of homotrimer) of asymmetric acetylcholinesterase], GenBank NM_{—}138417 [kti12 homolog, chromatin associated (s. cerevisiae)], GenBank NM_{—}145202 (proline-rich acidic protein 1), GenBank NM_{—}152392 [aha1, activator of heat shock 90 kda protein atpase homolog 2 (yeast)], GenBank NM_{—}173160 (fxyd domain containing ion transport regulator 4), GenBank XM_{—}039495, GenBank XM_{—}290629 (chromosome 14 open reading frame 78), GenBank AB014541 (apoptosis-associated tyrosine kinase), GenBank AB020695 (kiaa0888 protein), GenBank AF000562 (uroplakin 2), GenBank AF118072 (pro1716), GenBank AF134401 (espin), GenBank AF205437 [tribbles homolog 1 (drosophila)], GenBank AF210651 (nag18), GenBank AF211977 [leukocyte receptor cluster (lrc) member 10], GenBank AJ001348 (lymphocyte antigen 6 complex, locus k), GenBank AJ008151 (mitogen-activated protein kinase kinase kinase 14), GenBank AK024433 (mitochondrial ribosomal protein s25), GenBank AK024448 (cxyorfl-related protein), GenBank AK027024 [transcription elongation factor a (sii), 3], GenBank BE887356 (mitochondrial ribosomal protein 19), GenBank J03048 (hemopexin), GenBank L32786 [solute carrier family 25 (mitochondrial carrier; adenine nucleotide translocator), member 5], GenBank M26147 (deoxynucleotidyltransferase, terminal), GenBank M26747 [thyroid hormone receptor, beta (erythroblastic leukemia viral(v-erb-a) oncogene homolog 2, avian)], GenBank M81768 [solute carrier family 9 (sodium/hydrogen exchanger), member 1 (antiporter, na+/h+, amiloride sensitive)], GenBank NM_{—}000339 [solute carrier family 12 (sodium/chloride transporters), member 3], GenBank NM_{—}000356 (treacher collins-franceschetti syndrome 1), GenBank NM_{—}000715 (complement component 4 binding protein, alpha), GenBank NM_{—}001141 (arachidonate 15-lipoxygenase, type b), GenBank NM_{—}001171 [atp-binding cassette, sub-family c (cftr/mrp), member 6], GenBank NM_{—}001337 [chemokine (c-x3-c motif) receptor 1], GenBank NM_{—}001643 (apolipoprotein a-ii), GenBank NM_{—}001647 (apolipoprotein d), GenBank NM_{—}001683 (atpase, ca++ transporting, plasma membrane 2), GenBank NM_{—}001711 (biglycan), GenBank NM_{—}001783 [cd79a antigen (immunoglobulin-associated alpha)], GenBank NM_{—}001936 (dipeptidyl-peptidase 6), GenBank NM_{—}001951 (e2f transcription factor 5, p130-binding), GenBank NM_{—}001974 (egf-like module containing, mucin-like, hormone receptor-like 1), GenBank NM_{—}002309 [leukemia inhibitory factor (cholinergic differentiation factor)], GenBank NM_{—}003371 (vav 2 oncogene), GenBank NM_{—}003394 (wingless-type mmtv integration site family, member 10b), GenBank NM_{—}003641 [interferon induced transmembrane protein 1 (9-27)], GenBank NM_{—}003722 (tumor protein p73-like), GenBank NM_{—}004310 (ras homolog gene family, member h), GenBank NM_{—}004519 (potassium voltage-gated channel, kqt-like subfamily, member 3), GenBank NM_{—}005461 [v-maf musculoaponeurotic fibrosarcoma oncogene homolog b (avian)], GenBank NM_{—}005510 [dom-3 homolog z (c. elegans)], GenBank NM_{—}006399 (basic leucine zipper transcription factor, atf-like), GenBank NM_{—}006495 (ecotropic viral integration site 2b), GenBank NM_{—}006940 [sry (sex determining region y)-box 5], GenBank NM_{—}007267 (transmembrane channel-like 6), GenBank NM_{—}012190 (aldehyde dehydrogenase 1 family, member 11), GenBank NM_{—}014081, GenBank NM_{—}014151, GenBank NM_{—}014509 (kraken-like), GenBank NM_{—}015900 (phospholipase a1 member a), GenBank NM_{—}015950 (mitochondrial ribosomal protein 12), GenBank NM_{—}016356 (doublecortin domain containing 2), GenBank NM_{—}017753 (plasticity related gene 3), GenBank NM_{—}018199 (exonuclease 3′-5′ domain-like 2), GenBank NM_{—}018659 (cytokine-like 1), GenBank S49432 (collagen, type vi, alpha 3), GenBank S72620 (ews-fli1 protein), GenBank X52339 [zinc finger protein 708 (kox8)], GenBank X99631 (homeobox c12), GenBank Z36807 [mastermind-like 3 (drosophila)], GenBank AB208912 (guanylate binding protein 1, interferon-inducible, 67 kda), GenBank AB209019 (regulator of g-protein signalling 4), GenBank AB209032 (activating transcription factor 3), GenBank AB209172 [solute carrier family 6 (neurotransmitter transporter, taurine), member 6], GenBank AB209660 [cd40 antigen (tnf receptor superfamily member 5)], GenBank AB210026 (myosin, heavy polypeptide 10, non-muscle), GenBank AF023676 (transmembrane 7 superfamily member 2), GenBank AF033122 (sestrin 1), GenBank AF045459 (bmx non-receptor tyrosine kinase), GenBank AF053305 [bub1 budding uninhibited by benzimidazoles 1 homolog (yeast)], GenBank AF053306 [bub1 budding uninhibited by benzimidazoles 1 homolog beta (yeast)], GenBank AF332558 (bcl2 binding component 3), GenBank A1185409, GenBank AK024292, GenBank AK055797 (acyl-coa thioesterase 4), GenBank AK056803 (h2a histone family, member z), GenBank AK074377 (ubiquitin-like, containing phd and ring finger domains, 1), GenBank AK091170 [cyclin-dependent kinase inhibitor 2c (p18, inhibits cdk4)], GenBank AK122902 (transforming growth factor, beta 3), GenBank AK123010 (ribonucleotide reductase m2 polypeptide), GenBank AL833741 [enolase 1, (alpha)], GenBank AY123223 (sestrin 2), GenBank AY358868 [tumor necrosis factor (ligand) superfamily, member 18], GenBank AY750055 [diaphanous homolog 3 (drosophila)), GenBank BC003684 (coxsackie virus and adenovirus receptor), GenBank BC021008, GenBank BC032677 (ubiquitin-conjugating enzyme e2c), GenBank BC035407 [interleukin 3 receptor, alpha (low affinity)], GenBank BC043166 (potassium voltage-gated channel, shaker-related subfamily, beta member 1), GenBank BC043502 [nima (never in mitosis gene a)-related kinase 2], GenBank BC050630 (serine/threonine kinase 6 pseudogene), GenBank BC060797 [par-6 partitioning defective 6 homolog gamma (c. elegans)], GenBank BC063416 [phospholipase a2, group ivc (cytosolic, calcium-independent)], GenBank BU675073 (pituitary tumor-transforming 1), GenBank BX640641 (chromosome 6 open reading frame 107), GenBank CR590366 [midkine (neurite growth-promoting factor 2)], GenBank CR591317, GenBank CR604810 (cyclin a2), GenBank CR621398 (cell division cycle associated 3), GenBank CR623038 (inhibitor of dna binding 2, dominant negative helix-loop-helix protein), GenBank CR749832 (atpase family, aaa domain containing 2), GenBank CR933728 (cell division cycle 2, g1 to s and g2 to m), GenBank CR936755 (guanylate binding protein 3), GenBank D79987 [extra spindle poles like 1 (s. cerevisiae)], GenBank M30640 [selectin e (endothelial adhesion molecule 1)], GenBank NM_{—}001012271 [baculoviral iap repeat-containing 5 (survivin)], GenBank NM_{—}001012507, GenBank NM_{—}001024807 [amyloid beta (a4) precursor-like protein 1], GenBank NM_{—}001254 [cdc6 cell division cycle 6 homolog (s. cerevisiae)], GenBank NM_{—}001274 [chk1 checkpoint homolog (s. pombe)], GenBank NM_{—}001511 [chemokine (c-x-c motif) ligand 1 (melanoma growth stimulating activity, alpha)], GenBank NM_{—}001759 (cyclin d2), GenBank NM_{—}001773 (cd34 antigen), GenBank NM_{—}001789 (cell division cycle 25a), GenBank NM_{—}002156, GenBank NM_{—}002994 [chemokine (c-x-c motif) ligand 5], GenBank NM_{—}003326 [tumor necrosis factor (ligand) superfamily, member 4 (tax-transcriptionally activated glycoprotein 1, 34 kda)], GenBank NM_{—}003504 [cdc45 cell division cycle 45-like (s. cerevisiae)], GenBank NM_{—}003512, GenBank NM_{—}003620 (protein phosphatase 1d magnesium-dependent, delta isoform), GenBank NM_{—}004111 (flap structure-specific endonuclease 1), GenBank NM_{—}004523 (kinesin family member 11), GenBank NM_{—}004701 (cyclin b2), GenBank NM_{—}004938 (death-associated protein kinase 1), GenBank NM_{—}005532 (interferon, alpha-inducible protein 27), GenBank NM_{—}005915 [mcm6 minichromosome maintenance deficient 6 (mis5 homolog, s. pombe) (s. cerevisiae)], GenBank NM_{—}006716 [dbf4 homolog (s. cerevisiae)], GenBank NM_{—}006739 [mcm5 minichromosome maintenance deficient 5, cell division cycle 46 (s. cerevisiae)], GenBank NM_{—}006904 (protein kinase, dna-activated, catalytic polypeptide), GenBank NM_{—}006988 (adam metallopeptidase with thrombospondin type 1 motif, 1), GenBank NM_{—}012415 (fibrinogen silencer binding protein), GenBank NM_{—}013277 (rac gtpase activating protein 1), GenBank NM_{—}014762 (24-dehydrocholesterol reductase), GenBank NM_{—}015254 (kinesin family member 13b), GenBank NM_{—}016343 [centromere protein f, 350/400 ka (mitosin)], GenBank NM_{—}016426 (g-2 and s-phase expressed 1), GenBank NM_{—}019089, GenBank NM_{—}020530 (oncostatin m), GenBank NM_{—}021101 (claudin 1), GenBank NM_{—}024430 (proline-serine-threonine phosphatase interacting protein 2), GenBank NM_{—}032387 (wnk lysine deficient protein kinase 4), GenBank NM_{—}058229, GenBank NM_{—}144586, GenBank NM_{—}182776 [mcm7 minichromosome maintenance deficient 7 (s. cerevisiae)], GenBank R59856 [chemokine (c-x3-c motif) ligand 1], GenBank U18018 [ets variant gene 4 (eta enhancer binding protein, e1af)], GenBank U65410 [mad2 mitotic arrest deficient-like 1 (yeast)], GenBank W60781, GenBank NM_{—}000015 [n-acetyltransferase 2 (arylamine n-acetyltransferase)], GenBank NM_{—}000019 [acetyl-coenzyme a acetyltransferase 1 (acetoacetyl coenzyme a thiolase)], GenBank NM_{—}000051 [ataxia telangiectasia mutated (includes complementation groups a, c and d)], GenBank NM_{—}000104 (cytochrome p450, family 1, subfamily b, polypeptide 1), GenBank NM_{—}000106 (cytochrome p450, family 2, subfamily d, polypeptide 6), GenBank NM_{—}000120 [epoxide hydrolase 1, microsomal (xenobiotic)], GenBank NM_{—}000122 [excision repair cross-complementing rodent repair deficiency, complementation group 3 (xeroderma pigmentosum group b complementing)], GenBank NM_{—}000240 (monoamine oxidase a), GenBank NM_{—}000367 (thiopurine s-methyltransferase), GenBank NM_{—}000379 (xanthine dehydrogenase), GenBank NM_{—}000389 [cyclin-dependent kinase inhibitor 1a (p21, cip1)], GenBank NM_{—}000392 [atp-binding cassette, sub-family c (cftr/mrp), member 2], GenBank NM_{—}000394 (crystallin, alpha a), GenBank NM_{—}000443 [atp-binding cassette, sub-family b (mdr/tap), member 4], GenBank NM_{—}000454 [superoxide dismutase 1, soluble (amyotrophic lateral sclerosis 1 (adult))], GenBank NM_{—}000498 (cytochrome p450, family 11, subfamily b, polypeptide 2), GenBank NM_{—}000499 (cytochrome p450, family 1, subfamily a, polypeptide 1), GenBank NM_{—}000546 [tumor protein p53 (li-fraumeni syndrome)], GenBank NM_{—}000581 (glutathione peroxidase 1), GenBank NM_{—}000594 [tumor necrosis factor (tnf superfamily, member 2)], GenBank NM_{—}000595 [lymphotoxin alpha (tnf superfamily, member 1)], GenBank NM_{—}000636 (superoxide dismutase 2, mitochondrial), GenBank NM_{—}000637 (glutathione reductase), GenBank NM_{—}000639 [fas ligand (tnf superfamily, member 6)], GenBank NM_{—}000662 [n-acetyltransferase 1 (arylamine n-acetyltransferase)], GenBank NM_{—}000754 (catechol-o-methyltransferase), GenBank NM_{—}000755 (carnitine acetyltransferase), GenBank NM_{—}000758 [colony stimulating factor 2 (granulocyte-macrophage)], GenBank NM_{—}000761 (cytochrome p450, family 1, subfamily a, polypeptide 2), GenBank NM_{—}000762 (cytochrome p450, family 2, subfamily a, polypeptide 6), GenBank NM_{—}000767 (cytochrome p450, family 2, subfamily b, polypeptide 6), GenBank NM_{—}000770 (cytochrome p450, family 2, subfamily c, polypeptide 8), GenBank NM_{—}000771 (cytochrome p450, family 2, subfamily c, polypeptide 9), GenBank NM_{—}000773 (cytochrome p450, family 2, subfamily e, polypeptide 1), GenBank NM_{—}000774 (cytochrome p450, family 2, subfamily f, polypeptide 1), GenBank NM_{—}000777 (cytochrome p450, family 3, subfamily a, polypeptide 5), GenBank NM_{—}000778 (cytochrome p450, family 4, subfamily a, polypeptide 11), GenBank NM_{—}000779 (cytochrome p450, family 4, subfamily b, polypeptide 1), GenBank NM_{—}000780 (cytochrome p450, family 7, subfamily a, polypeptide 1), GenBank NM_{—}000781 (cytochrome p450, family 11, subfamily a, polypeptide 1), GenBank NM_{—}000782 (cytochrome p450, family 24, subfamily a, polypeptide 1), GenBank NM_{—}000847 (glutathione s-transferase a3), GenBank NM_{—}000848 [glutathione s-transferase m2 (muscle)], GenBank NM_{—}000849 [glutathione s-transferase m3 (brain)], GenBank NM_{—}000851 (glutathione s-transferase m5), GenBank NM_{—}000852 (glutathione s-transferase pi), GenBank NM_{—}000853 (glutathione s-transferase theta 1), GenBank NM_{—}000854 (glutathione s-transferase theta 2), GenBank NM_{—}000896 (cytochrome p450, family 4, subfamily f, polypeptide 3), GenBank NM_{—}000898 (monoamine oxidase b), GenBank NM_{—}000927 [atp-binding cassette, sub-family b (mdr/tap), member 1], GenBank NM_{—}000940 (paraoxonase 3), GenBank NM_{—}000941 [p450 (cytochrome) oxidoreductase], GenBank NM_{—}000962 [prostaglandin-endoperoxide synthase 1 (prostaglandin g/h synthase and cyclooxygenase)], GenBank NM_{—}000963 [prostaglandin-endoperoxide synthase 2 (prostaglandin g/h synthase and cyclooxygenase)], GenBank NM_{—}001055 (sulfotransferase family, cytosolic, 1a, phenol-preferring, member 1), GenBank NM_{—}001056 (sulfotransferase family, cytosolic, 1c, member 1), GenBank NM_{—}001061 [thromboxane a synthase 1 (platelet, cytochrome p450, family 5, subfamily a)]], GenBank NM_{—}001065 (tumor necrosis factor receptor superfamily, member 1a), GenBank NM_{—}001228 (caspase 8, apoptosis-related cysteine peptidase), GenBank NM_{—}001230 (caspase 10, apoptosis-related cysteine peptidase), GenBank NM_{—}001235 [serpin peptidase inhibitor, clade h (heat shock protein 47), member 1, (collagen binding protein 1)), GenBank NM_{—}001512 (glutathione s-transferase a4), GenBank NM_{—}001539 [dnaj (hsp40) homolog, subfamily a, member 1], GenBank NM_{—}001540 (heat shock 27 kda protein 1), GenBank NM_{—}001562 [interleukin 18 (interferon-gamma-inducing factor)], GenBank NM_{—}001565 [chemokine (c-x-c motif) ligand 10], GenBank NM_{—}001609 (acyl-coenzyme a dehydrogenase, short/branched chain), GenBank NM_{—}001746 (calnexin), GenBank NM_{—}001752 (catalase), GenBank NM_{—}001831 (clusterin), GenBank NM_{—}001885 (crystallin, alpha b), GenBank NM_{—}001924 (growth arrest and dna-damage-inducible, alpha), GenBank NM_{—}001931 [dihydrolipoamide s-acetyltransferase (e2 component of pyruvate dehydrogenase complex)], GenBank NM_{—}001964 (early growth response 1), GenBank NM_{—}001979 (epoxide hydrolase 2, cytoplasmic), GenBank NM_{—}001983 [excision repair cross-complementing rodent repair deficiency, complementation group 1 (includes overlapping antisense sequence)], GenBank NM_{—}002021 (flavin containing monooxygenase 1), GenBank NM_{—}002022 (flavin containing monooxygenase 4), GenBank NM_{—}002046 (glyceraldehyde-3-phosphate dehydrogenase), GenBank NM_{—}002083 [glutathione peroxidase 2 (gastrointestinal)], GenBank NM_{—}002133 [heme oxygenase (decycling) 1], GenBank NM_{—}002134 [heme oxygenase (decycling) 2], GenBank NM_{—}002154 (heat shock 70 kda protein 4), GenBank NM_{—}002155 [heat shock 70 kda protein 6 (hsp70b′)], GenBank NM_{—}002157 [heat shock 10 kda protein 1 (chaperonin 10)], GenBank NM_{—}002178 (insulin-like growth factor binding protein 6), GenBank NM_{—}002413 (microsomal glutathione s-transferase 2), GenBank NM_{—}002415 [macrophage migration inhibitory factor (glycosylation-inhibiting factor)], GenBank NM_{—}002452 [nudix (nucleoside diphosphate linked moiety x)-type motif 1], GenBank NM_{—}002574 (peroxiredoxin 1), GenBank NM_{—}002983 [chemokine (c-c motif) ligand 3], GenBank NM_{—}002984 [chemokine (c-c motif) ligand 4], GenBank NM_{—}002989 [chemokine (c-c motif) ligand 21], GenBank NM_{—}003167 [sulfotransferase family, cytosolic, 2a, dehydroepiandrosterone(dhea)-preferring, member 1], GenBank NM_{—}003299 [heat shock protein 90 kda beta (grp94), member 1], GenBank NM_{—}003315 [dnaj (hsp40) homolog, subfamily c, member 7], GenBank NM_{—}003595 (tyrosylprotein sulfotransferase 2), GenBank NM_{—}003596 (tyrosylprotein sulfotransferase 1), GenBank NM_{—}003642 (histone acetyltransferase 1), GenBank NM_{—}003654 [carbohydrate (keratan sulfate gal-6) sulfotransferase 1], GenBank NM_{—}003786 [atp-binding cassette, sub-family c (cftr/mrp), member 3], GenBank NM_{—}003789 (tnfrsf1a-associated via death domain), GenBank NM_{—}003810 [tumor necrosis factor (ligand) superfamily, member 10], GenBank NM_{—}003932 [suppression of tumorigenicity 13 (colon carcinoma) (hsp70 interacting protein)], GenBank NM_{—}003998 [nuclear factor of kappa light polypeptide gene enhancer in b-cells 1 (p105)], GenBank NM_{—}004048 (beta-2-microglobulin), GenBank NM_{—}004050 (bcl2-like 2), GenBank NM_{—}004060 (cyclin g1), GenBank NM_{—}004083 (dna-damage-inducible transcript 3), GenBank NM_{—}004134 [heat shock 70 kda protein 9b (mortalin-2)], GenBank NM_{—}004267 [carbohydrate (n-acetylglucosamine-6-o) sulfotransferase 2], GenBank NM_{—}004273 [carbohydrate (chondroitin 6) sulfotransferase 3], GenBank NM_{—}004323 (bcl2-associated athanogene), GenBank NM_{—}004324 (bcl2-associated x protein), GenBank NM_{—}004343 (calreticulin), GenBank NM_{—}004391 (cytochrome p450, family 8, subfamily b, polypeptide 1), GenBank NM_{—}004528 (microsomal glutathione s-transferase 3), GenBank NM_{—}004605 (sulfotransferase family, cytosolic, 2b, member 1), GenBank NM_{—}004820 (cytochrome p450, family 7, subfamily b, polypeptide 1), GenBank NM_{—}004827 [atp-binding cassette, sub-family g (white), member 2], GenBank NM_{—}004832 (glutathione s-transferase omega 1), GenBank NM_{—}004854 (carbohydrate sulfotransferase 10), GenBank NM_{—}004861 (galactose-3-o-sulfotransferase 1), GenBank NM_{—}004996 [atp-binding cassette, sub-family c (cftr/mrp), member 1], GenBank NM_{—}005053 [rad23 homolog a (s. cerevisiae)], GenBank NM_{—}005147 [dnaj (hsp40) homolog, subfamily a, member 3], GenBank NM_{—}005190 (cyclin c), GenBank NM_{—}005225 (e2f transcription factor 1), GenBank NM_{—}005345 (heat shock 70 kda protein 1 a), GenBank NM_{—}005347 [heat shock 70 kda protein 5 (glucose-regulated protein, 78 kda)], GenBank NM_{—}005348 [heat shock protein 90 kda alpha (cytosolic), class a member 1], GenBank NM_{—}005420 (sulfotransferase family 1e, estrogen-preferring, member 1), GenBank NM_{—}005431 (x-ray repair complementing defective repair in Chinese hamster cells 2), GenBank NM_{—}005526 (heat shock transcription factor 1), GenBank NM_{—}005527 (heat shock 70 kda protein 1-like), GenBank NM_{—}005528 [dnaj (hsp40) homolog, subfamily c, member 4], GenBank NM_{—}005688 [atp-binding cassette, sub-family c (cftr/mrp), member 5], GenBank NM_{—}005732 [rad50 homolog (s. cerevisiae)], GenBank NM_{—}005769 [carbohydrate (n-acetylglucosamine 6-o) sulfotransferase 4], GenBank NM_{—}005809 (peroxiredoxin 2), GenBank NM_{—}005880 [dnaj (hsp40) homolog, subfamily a, member 2], GenBank NM_{—}005952 (metallothionein 1x), GenBank NM_{—}005953 (metallothionein 2a), GenBank NM_{—}005954 [metallothionein 3 (growth inhibitory factor (neurotrophic))], GenBank NM_{—}005998 [chaperonin containing tcp1, subunit 3 (gamma)], GenBank NM_{—}006145 [dnaj (hsp40) homolog, subfamily b, member 1], GenBank NM_{—}006169 (nicotinamide n-methyltransferase), GenBank NM_{—}006308 (heat shock 27 kda protein 3), GenBank NM_{—}006389 (hypoxia up-regulated 1), GenBank NM_{—}006429 [chaperonin containing tcp1, subunit 7 (eta)], GenBank NM_{—}006430 [chaperonin containing tcp1, subunit 4 (delta)], GenBank NM_{—}006431 [chaperonin containing tcp1, subunit 2 (beta)], GenBank NM_{—}006585 [chaperonin containing tcp1, subunit 8 (theta)], GenBank NM_{—}006588 (sulfotransferase family, cytosolic, 1c, member 2), GenBank NM_{—}006597 (heat shock 70 kda protein 8), GenBank NM_{—}006644 (heat shock 105 kda/110 kda protein 1), GenBank NM_{—}006736 [dnaj (hsp40) homolog, subfamily b, member 2], GenBank NM_{—}006895 (histamine n-methyltransferase), GenBank NM_{—}007034 [dnaj (hsp40) homolog, subfamily b, member 4], GenBank NM_{—}007067 (myst histone acetyltransferase 2), GenBank NM_{—}007194 [chk2 checkpoint homolog (s. pombe)], GenBank NM_{—}007326 (cytochrome b5 reductase 3), GenBank NM_{—}007355 [heat shock protein 90 kda alpha (cytosolic), class b member 1], GenBank NM_{—}012073 [chaperonin containing tcp1, subunit 5 (epsilon)], GenBank NM_{—}012126 [carbohydrate (n-acetylglucosamine 6-o) sulfotransferase 5], GenBank NM_{—}012266 [dnaj (hsp40) homolog, subfamily b, member 5], GenBank NM_{—}012328 [dnaj (hsp40) homolog, subfamily b, member 9], GenBank NM_{—}012330 [myst histone acetyltransferase (monocytic leukemia) 4], GenBank NM_{—}012423 (ribosomal protein 113a), GenBank NM_{—}014280 [dnaj (hsp40) homolog, subfamily c, member 8], GenBank NM_{—}014351 (sulfotransferase family 4a, member 1), GenBank NM_{—}014465 (sulfotransferase family, cytosolic, 1b, member 1), GenBank NM_{—}015675 (growth arrest and dna-damage-inducible, beta), GenBank NM_{—}016100 [n-acetyltransferase 5 (ardl homolog, s. cerevisiae)], GenBank NM_{—}016280 (carboxylesterase 4-like), GenBank NM_{—}016306 [dnaj (hsp40) homolog, subfamily b, member 11], GenBank NM_{—}017460 [cytochrome p450, subfamily iiia (niphedipine oxidase), polypeptide 3], GenBank NM_{—}018602 [dnaj (hsp40) homolog, subfamily a, member 4], GenBank NM_{—}019885 (cytochrome p450, family 26, subfamily b, polypeptide 1), GenBank NM_{—}019886 [carbohydrate (n-acetylglucosamine 6-o) sulfotransferase 7], GenBank NM_{—}020300 (microsomal glutathione s-transferase 1), GenBank NM_{—}020529 (nuclear factor of kappa light polypeptide gene enhancer in b-cells inhibitor, alpha), GenBank NM_{—}020674 (cytochrome p450, family 20, subfamily a, polypeptide 1), GenBank NM_{—}020985 (choline acetyltransferase), GenBank NM_{—}021130 [peptidylprolyl isomerase a (cyclophilin a)], GenBank NM_{—}021615 [carbohydrate (n-acetylglucosamine 6-o) sulfotransferase 6], GenBank NM_{—}021979 (heat shock 70 kda protein 2), GenBank NM_{—}022467 [carbohydrate (n-acetylgalactosamine 4-0) sulfotransferase 8], GenBank NM_{—}025219 [dnaj (hsp40) homolog, subfamily c, member 5], GenBank NM_{—}030752 (t-complex 1), GenBank NM_{—}033292 [caspase 1, apoptosis-related cysteine peptidase (interleukin 1, beta, convertase)], GenBank NM_{—}053056 (cyclin d1), GenBank NM_{—}138578 (bcl2-like 1), GenBank NM_{—}139211 (homeodomain-only protein), GenBank NM_{—}182649 (proliferating cell nuclear antigen).

1) Marker genes whose expressions are changed by the treatment of a drug causing pulmonary toxicity are as follows:

GenBank A_{—}24_P349756, GenBank AA995107 (interleukin 7 receptor), GenBank AB044088 (basic helix-loop-helix domain containing, class b, 3), GenBank AB195679 (hypothetical protein flj20366), GenBank AF289615 (hypothetical protein), GenBank AK024898, GenBank AK027210 (dual specificity phosphatase 14), GenBank AK095849 (major histocompatibility complex, class i, a), GenBank AK098095 (v-raf murine sarcoma viral oncogene homolog b1), GenBank AK124635 (proprotein convertase subtilisin/kexin type 9), GenBank AK125636 [glutaredoxin (thioltransferase)], GenBank AK127679 (dual specificity phosphatase 1), GenBank AK131071 [solute carrier family 31 (copper transporters), member 2], GenBank AL832142 (g protein-coupled receptor 137b), GenBank AL832445 (hypothetical protein flj25770), GenBank AY247738 [tribbles homolog 3 (drosophila)], GenBank AY367065 (hypothetical protein flj10517), GenBank BC008678 (interleukin 1, beta), GenBank BC021552 (calcium channel, voltage-dependent, gamma subunit 6), GenBank BC031405 (dual specificity phosphatase 10), GenBank BC043371 [growth factor independent 1b (potential regulator of cdknla, translocated in cml)], GenBank BC052951 (lamin b1), GenBank BC053653 [chemokine (c-x-c motif) ligand 2], GenBank BC065304 (dep domain containing 1), GenBank BC065544 (putative protein p243 which interacts with transcription factor sp1), GenBank BC069137 [interleukin 5 (colony-stimulating factor, eosinophil)], GenBank BE300829, GenBank BG564326 (serum amyloid a4, constitutive), GenBank BG564669 (serum amyloid a1), GenBank BM906235 (inhibitor of dna binding 3, dominant negative helix-loop-helix protein), GenBank BM918324 (lymphocyte antigen 96), GenBank BU845177 [ras-related c3 botulinum toxin substrate 1 (rho family, small gtp binding protein rac1)], GenBank BX648583 (egf-like repeats and discoidin i-like domains 3), GenBank CR614015 (cd14 antigen), GenBank CR618407 (bone morphogenetic protein 2), GenBank CR936799 (four and a half lim domains 2), GenBank D26122 (splicing factor 1), GenBank D63880 (chromosome condensation-related smc-associated protein 1), GenBank M92424 [mdm2, transformed 3t3 cell double minute 2, p53 binding protein (mouse)], GenBank NM_{—}000189 (hexokinase 2), GenBank NM_{—}000575 (interleukin 1, alpha), GenBank NM_{—}000600 [interleukin 6 (interferon, beta 2)], GenBank NM_{—}000641 (interleukin 11), GenBank NM_{—}000944 [protein phosphatase 3 (formerly 2b), catalytic subunit, alpha isoform (calcineurin a alpha)], GenBank NM_{—}001001958 (olfactory receptor, family 7, subfamily g, member 3), GenBank NM_{—}001025077 (cug triplet repeat, rna binding protein 2), GenBank NM_{—}001295 [chemokine (c-c motif) receptor 1], GenBank NM_{—}001733 (complement component 1, r subcomponent), GenBank NM_{—}001734 (complement component 1, s subcomponent), GenBank NM_{—}002260 (killer cell lectin-like receptor subfamily c, member 2), GenBank NM_{—}002305 [lectin, galactoside-binding, soluble, 1 (galectin 1)], GenBank NM_{—}003629 [phosphoinositide-3-kinase, regulatory subunit 3 (p55, gamma)], GenBank NM_{—}003955 (suppressor of cytokine signaling 3), GenBank NM_{—}004265 (fatty acid desaturase 2), GenBank NM_{—}004293 (guanine deaminase), GenBank NM_{—}004759 (mitogen-activated protein kinase-activated protein kinase 2), GenBank NM_{—}004864 (growth differentiation factor 15), GenBank NM_{—}006464 (trans-golgi network protein 2), GenBank NM_{—}007371 (bromodomain containing 3), GenBank NM_{—}012338 (tetraspanin 12), GenBank NM_{—}013372 [gremlin 1, cysteine knot superfamily, homolog (xenopus laevis)], GenBank NM_{—}014391 [ankyrin repeat domain 1 (cardiac muscle)], GenBank NM_{—}014707 (histone deacetylase 9), GenBank NM_{—}022726 [elongation of very long chain fatty acids (fen1/elo2, sur4/elo3, yeast)-like 4], GenBank NM_{—}030754 (serum amyloid a2), GenBank NM_{—}134470 (interleukin 1 receptor accessory protein), GenBank NM_{—}139314 (angiopoietin-like 4), GenBank NM_{—}172220 [colony stimulating factor 3 (granulocyte)], GenBank NM_{—}198187 (astrotactin 2), GenBank NM_{—}199511 (steroid sensitive gene 1), GenBank NM_{—}207035 (chromosome 1 open reading frame 63), GenBank U68019 [smad, mothers against dpp homolog 3 (drosophila)], GenBank X96753 [chondroitin sulfate proteoglycan 4 (melanoma-associated)].

2) Marker genes whose expressions are changed by the treatment of a drug causing teratogenicity are as follows:

GenBank AB018258 (ATPase, class v, type 10b), GenBank AB209845 (transcription termination factor, rna polymerase ii variant), GenBank AF001893 (trophoblast-derived noncoding rna), GenBank AK001879 (hypothetical protein flj11017), GenBank AK023571 (zinc finger protein 100), GenBank AK023574 (zinc finger rna binding protein), GenBank AK057515, GenBank AK095632 [ankyrin repeat and btb (poz) domain containing 2], GenBank AK122757 [melanocortin 1 receptor (alpha melanocyte stimulating hormone receptor)], GenBank AK125877 (hypothetical protein mgc27016), GenBank AK126731 (islet cell autoantigen 1, 69 kda), GenBank BC036890 [grainyhead-like 3 (drosophila)], GenBank BC042755 (regulator of g-protein signalling 2, 24 kda), GenBank BC063830 [st6 (alpha-n-acetyl-neuraminyl-2,3-beta-galactosyl-1,3)-n-acetylgalactosaminide alpha-2,6-sialyltransferase 1], GenBank BX111592, GenBank BX648021 (v-set domain containing t cell activation inhibitor 1), GenBank BX649112 (cobl-like 1), GenBank NM_{—}000735 (glycoprotein hormones, alpha polypeptide), GenBank NM_{—}001003793 (RNA binding motif, single stranded interacting protein), GenBank NM_{—}001618 [poly (adp-ribose) polymerase family, member 1], GenBank NM_{—}002356 (myristoylated alanine-rich protein kinase c substrate), GenBank NM_{—}004155 [serpin peptidase inhibitor, clade b (ovalbumin), member 9], GenBank NM_{—}004615 (tetraspanin 7), GenBank NM_{—}005668 (st8 alpha-n-acetyl-neuraminide alpha-2,8-sialyltransferase 4), GenBank NM_{—}018018 (solute carrier family 38, member 4), GenBank NM_{—}024342 (glucocorticoid receptor dna binding factor 1), GenBank NM_{—}032484 (homolog of mouse lgp1), GenBank NM_{—}181659 (nuclear receptor coactivator 3), GenBank XM_{—}031553 (u2-associated sr140 protein), GenBank Y18483 [solute carrier family 7 (cationic amino acid transporter, y+ system), member 8].

3) Marker genes whose expressions are changed by the treatment of a drug causing nephrotoxicity are as follows:

GenBank AB018270 (myosin id), GenBank AB040955 (kiaa1522), GenBank AB075871 (hypothetical protein hmfn1187), GenBank AF097935 (desmoglein 1), GenBank AF279145 (tumor endothelial marker 8), GenBank AF307451 (cat eye syndrome chromosome region, candidate 6), GenBank AJ002535 (hypothetical protein flj14124), GenBank AK001361 [protein phosphatase 1, regulatory (inhibitor) subunit 15a], GenBank AK023662 (chromosome 9 open reading frame 44), GenBank AK024144 (hypothetical protein flj14082), GenBank AK025974 (hypothetical protein mgc2574), GenBank AK026909 (disrupter of silencing 10), GenBank AK074052 (tripartite motif-containing 41), GenBank AK094580 (serine/threonine kinase 32a), GenBank AK095253 (bystin-like), GenBank AK096265 (sushi domain containing 4), GenBank AK096289 (thrombospondin, type i, domain containing 1), GenBank AK122912 (lck interacting transmembrane adaptor 1), GenBank AL136662 (chromosome 15 open reading frame 44), GenBank AL833764 [fer-1-like 4 (c. elegans)], GenBank AY008294 [zinc finger protein, subfamily 1a, 2 (helios)], GenBank AY129013 (tbc1 domain family, member 17), GenBank AY203954 [rna binding motif (rnpl, rrm) protein 3], GenBank AY358993 (keratinocyte associated protein 3), GenBank AY706204 [sin3 homolog b, transcription regulator (yeast)], GenBank BC004102 (aldehyde dehydrogenase 3 family, memberal), GenBank BC025741 (chromosome 16 open reading frame 54), GenBank BC033515 (lysm, putative peptidoglycan-binding, domain containing 2), GenBank BC040191 (solute carrier family 35, member e4), GenBank BC051890 (tubulin, gamma 2), GenBank BC067751 [v-maf musculoaponeurotic fibrosarcoma oncogene homolog f (avian)], GenBank BC073828 [protein phosphatase 1j (pp2c domain containing)], GenBank BE889572 (receptor transporter protein 4), GenBank BM542003 (wd repeat domain 54), GenBank BM555452 (tumor necrosis factor receptor superfamily, member 12a), GenBank BU673968 [rio kinase 3 (yeast)], GenBank BX537620 [3-hydroxy-3-methylglutaryl-coenzyme a synthase 1 (soluble)], GenBank BX640959 (hypothetical protein flj14213), GenBank CR601067 (plasminogen activator, urokinase receptor), GenBank CR613579 (growth arrest and dna-damage-inducible, gamma), GenBank D67025 [proteasome (prosome, macropain) 26s subunit, non-atpase, 3], GenBank NM_{—}000134 (fatty acid binding protein 2, intestinal), GenBank NM_{—}001001524 (transmembrane 6 superfamily member 2), GenBank NM_{—}001004703 (olfactory receptor, family 4, subfamily c, member 46), GenBank NM_{—}001005190 (olfactory receptor, family 7, subfamily a, member 10), GenBank NM_{—}001010867 (chromosome 1 open reading frame 69), GenBank NM_{—}001215 (carbonic anhydrase vi), GenBank NM_{—}002409 [mannosyl(beta-1,4-)-glycoprotein beta-1,4-n-acetylglucosaminyltransferase], GenBank NM_{—}002918 [regulatory factor x, 1 (influences hla class ii expression)], GenBank NM_{—}005203 (collagen, type xiii, alpha 1), GenBank NM_{—}005247 [fibroblast growth factor 3 (murine mammary tumor virus integration site (v-int-2) oncogene homolog)], GenBank NM_{—}005310 (growth factor receptor-bound protein 7), GenBank NM_{—}012110 (cysteine-rich hydrophobic domain 2), GenBank NM_{—}014323 (zinc finger protein 278), GenBank NM_{—}015946 (pro1770 protein), GenBank NM_{—}020458 (tetratricopeptide repeat domain 7a), GenBank NM_{—}031298 (transmembrane protein 93), GenBank NM_{—}080542 [collagen-like tail subunit (single strand of homotrimer) of asymmetric acetylcholinesterase], GenBank NM_{—}138417 [kti12 homolog, chromatin associated (s. cerevisiae)], GenBank NM_{—}145202 (proline-rich acidic protein 1), GenBank NM_{—}152392 [aha1, activator of heat shock 90 kda protein atpase homolog 2 (yeast)], GenBank NM_{—}173160 (fxyd domain containing ion transport regulator 4), GenBank XM_{—}039495, GenBank XM_{—}290629 (chromosome 14 open reading frame 78).

4) Marker genes whose expressions are changed by the treatment of a drug causing mutation are as follows:

GenBank AB014541 (apoptosis-associated tyrosine kinase), GenBank AB020695 (kiaa0888 protein), GenBank AF000562 (uroplakin 2), GenBank AF118072 (pro1716), GenBank AF134401 (espin), GenBank AF205437 [tribbles homolog 1 (drosophila)], GenBank AF210651 (nag18), GenBank AF211977 [leukocyte receptor cluster (lrc) member 10], GenBank AJ001348 (lymphocyte antigen 6 complex, locus k), GenBank AJ008151 (mitogen-activated protein kinase kinase kinase 14), GenBank AK024433 (mitochondrial ribosomal protein s25), GenBank AK024448 (cxyorf1-related protein), GenBank AK027024 [transcription elongation factor a (sii), 3], GenBank BE887356 (mitochondrial ribosomal protein 19), GenBank J03048 (hemopexin), GenBank L32786 [solute carrier family 25 (mitochondrial carrier; adenine nucleotide translocator), member 5], GenBank M26147 (deoxynucleotidyltransferase, terminal), GenBank M26747 [thyroid hormone receptor, beta (erythroblastic leukemia viral (v-erb-a) oncogene homolog 2, avian)], GenBank M81768 [solute carrier family 9 (sodium/hydrogen exchanger), member 1 (antiporter, na+/h+, amiloride sensitive)], GenBank NM_{—}000339 [solute carrier family 12 (sodium/chloride transporters), member 3], GenBank NM_{—}000356 (treacher collins-franceschetti syndrome 1), GenBank NM_{—}000715 (complement component 4 binding protein, alpha), GenBank NM_{—}001141 (arachidonate 15-lipoxygenase, type b), GenBank NM_{—}001171 [atp-binding cassette, sub-family c (cftr/mrp), member 6], GenBank NM_{—}001337 [chemokine (c-x3-c motif) receptor 1], GenBank NM_{—}001643 (apolipoprotein a-ii), GenBank NM_{—}001647 (apolipoprotein d), GenBank NM_{—}001683 (atpase, ca++ transporting, plasma membrane 2), GenBank NM_{—}001711 (biglycan), GenBank NM_{—}001783 [cd79a antigen (immunoglobulin-associated alpha)], GenBank NM_{—}001936 (dipeptidyl-peptidase 6), GenBank NM_{—}001951 (e2f transcription factor 5, p130-binding), GenBank NM_{—}001974 (egf-like module containing, mucin-like, hormone receptor-like 1), GenBank NM_{—}002309 [leukemia inhibitory factor (cholinergic differentiation factor)], GenBank NM_{—}003371 (vav 2 oncogene), GenBank NM_{—}003394 (wingless-type mmtv integration site family, member 10b), GenBank NM_{—}003641 [interferon induced transmembrane protein 1 (9-27)], GenBank NM_{—}003722 (tumor protein p73-like), GenBank NM_{—}004310 (ras homolog gene family, member h), GenBank NM_{—}004519 (potassium voltage-gated channel, kqt-like subfamily, member 3), GenBank NM_{—}005461 [v-maf musculoaponeurotic fibrosarcoma oncogene homolog b (avian)], GenBank NM_{—}005510 [dom-3 homolog z (c. elegans)], GenBank NM_{—}006399 (basic leucine zipper transcription factor, atf-like), GenBank NM_{—}006495 (ecotropic viral integration site 2b), GenBank NM_{—}006940 [sry (sex determining region y)-box 5], GenBank NM_{—}007267 (transmembrane channel-like 6), GenBank NM_{—}012190 (aldehyde dehydrogenase 1 family, member 11), GenBank NM_{—}014081, GenBank NM_{—}014151, GenBank NM_{—}014509 (kraken-like), GenBank NM_{—}015900 (phospholipase a1 member a), GenBank NM_{—}015950 (mitochondrial ribosomal protein 12), GenBank NM_{—}016356 (doublecortin domain containing 2), GenBank NM_{—}017753 (plasticity related gene 3), GenBank NM_{—}018199 (exonuclease 3′-5′ domain-like 2), GenBank NM_{—}018659 (cytokine-like 1), GenBank S49432 (collagen, type vi, alpha 3), GenBank S72620 (ews-flil protein), GenBank X52339 [zinc finger protein 708 (kox8)], GenBank X99631 (homeobox c12), GenBank Z36807 [mastermind-like 3 (drosophila)].

5) Marker genes whose expressions are changed by the treatment of a drug causing cardiotoxicity are as follows:

GenBank AB208912(guanylate binding protein 1, interferon-inducible, 67 kda), GenBank AB209019(regulator of g-protein signalling 4), GenBank AB209032(activating transcription factor 3), GenBank AB209172 [solute carrier family 6(neurotransmitter transporter, taurine), member 6], GenBank AB209660 [cd40 antigen (tnf receptor superfamily member 5)], GenBank AB210026 (myosin, heavy polypeptide 10, non-muscle), GenBank AF023676 (transmembrane 7 superfamily member 2), GenBank AF033122 (sestrin 1), GenBank AF045459 (bmx non-receptor tyrosine kinase), GenBank AF053305 [bub1 budding uninhibited by benzimidazoles 1 homolog (yeast)], GenBank AF053306 [bub1 budding uninhibited by benzimidazoles 1 homolog beta (yeast)], GenBank AF332558 (bcl2 binding component 3), GenBank AI185409, GenBank AK024292, GenBank AK055797(acyl-coa thioesterase 4), GenBank AK056803 (h2a histone family, member z), GenBank AK074377 (ubiquitin-like, containing phd and ring finger domains, 1), GenBank AK091170 [cyclin-dependent kinase inhibitor 2c (p18, inhibits cdk4)], GenBank AK122902 (transforming growth factor, beta 3), GenBank AK123010 (ribonucleotide reductase m2 polypeptide), GenBank AL833741 [enolase 1, (alpha)], GenBank AY123223 (sestrin 2), GenBank AY358868 [tumor necrosis factor (ligand) superfamily, member 18], GenBank AY750055 [diaphanous homolog 3 (drosophila)), GenBank BC003684 (coxsackie virus and adenovirus receptor), GenBank BC021008, GenBank BC032677 (ubiquitin-conjugating enzyme e2c), GenBank BC035407 [interleukin 3 receptor, alpha (low affinity)], GenBank BC043166 (potassium voltage-gated channel, shaker-related subfamily, beta member 1), GenBank BC043502 [nima (never in mitosis gene a)-related kinase 2], GenBank BC050630 (serine/threonine kinase 6 pseudogene), GenBank BC060797 [par-6 partitioning defective 6 homolog gamma (c. elegans)], GenBank BC063416 [phospholipase a2, group ivc (cytosolic, calcium-independent)], GenBank BU675073 (pituitary tumor-transforming 1), GenBank BX640641 (chromosome 6 open reading frame 107), GenBank CR590366 [midkine (neurite growth-promoting factor 2)], GenBank CR591317, GenBank CR604810 (cyclin a2), GenBank CR621398 (cell division cycle associated 3), GenBank CR623038 (inhibitor of dna binding 2, dominant negative helix-loop-helix protein), GenBank CR749832 (atpase family, aaa domain containing 2), GenBank CR933728 (cell division cycle 2, g1 to s and g2 to m), GenBank CR936755 (guanylate binding protein 3), GenBank D79987 [extra spindle poles like 1 (s. cerevisiae)], GenBank M30640 [selectin e (endothelial adhesion molecule 1)], GenBank NM_{—}001012271 [baculoviral iap repeat-containing 5 (survivin)], GenBank NM_{—}001012507, GenBank NM_{—}001024807 [amyloid beta (a4) precursor-like protein 1], GenBank NM_{—}001254 [cdc6 cell division cycle 6 homolog (s. cerevisiae)], GenBank NM_{—}001274 [chk1 checkpoint homolog (s. pombe)], GenBank NM_{—}001511 [chemokine (c-x-c motif) ligand 1 (melanoma growth stimulating activity, alpha)], GenBank NM_{—}001759 (cyclin d2), GenBank NM_{—}001773 (cd34 antigen), GenBank NM_{—}001789 (cell division cycle 25a), GenBank NM_{—}002156, GenBank NM_{—}002994 [chemokine (c-x-c motif) ligand 5], GenBank NM_{—}003326 [tumor necrosis factor (ligand) superfamily, member 4 (tax-transcriptionally activated glycoprotein 1, 34 kda)], GenBank NM_{—}003504 [cdc45 cell division cycle 45-like (s. cerevisiae)], GenBank NM_{—}003512, GenBank NM_{—}003620 (protein phosphatase 1d magnesium-dependent, delta isoform), GenBank NM_{—}004111 (flap structure-specific endonuclease 1), GenBank NM_{—}004523 (kinesin family member 11), GenBank NM_{—}004701 (cyclin b2), GenBank NM_{—}004938 (death-associated protein kinase 1), GenBank NM_{—}005532 (interferon, alpha-inducible protein 27), GenBank NM_{—}005915 [mcm6 minichromosome maintenance deficient 6 (mis5 homolog, s. pombe) (s. cerevisiae)], GenBank NM_{—}006716 [dbf4 homolog (s. cerevisiae)], GenBank NM_{—}006739 [mcm5 minichromosome maintenance deficient 5, cell division cycle 46 (s. cerevisiae)], GenBank NM_{—}006904 (protein kinase, dna-activated, catalytic polypeptide), GenBank NM_{—}006988 (adam metallopeptidase with thrombospondin type 1 motif, 1), GenBank NM_{—}012415 (fibrinogen silencer binding protein), GenBank NM_{—}013277 (rac gtpase activating protein 1), GenBank NM_{—}014762 (24-dehydrocholesterol reductase), GenBank NM_{—}015254 (kinesin family member 13b), GenBank NM_{—}016343 [centromere protein f, 350/400 ka (mitosin)], GenBank NM_{—}016426 (g-2 and s-phase expressed 1), GenBank NM_{—}019089, GenBank NM_{—}020530 (oncostatin m), GenBank NM_{—}021101 (claudin 1), GenBank NM_{—}024430 (proline-serine-threonine phosphatase interacting protein 2), GenBank NM_{—}032387 (wnk lysine deficient protein kinase 4), GenBank NM_{—}058229, GenBank NM_{—}144586, GenBank NM_{—}182776 [mcm7 minichromosome maintenance deficient 7 (s. cerevisiae)], GenBank R59856 [chemokine (c-x3-c motif) ligand 1], GenBank U18018 [ets variant gene 4 (e1a enhancer binding protein, elaf)], GenBank U65410 [mad2 mitotic arrest deficient-like 1 (yeast)], GenBank W60781.

6) Marker genes whose expressions are changed by the treatment of a drug causing general toxicity are as follows:

GenBank NM_{—}000015 [n-acetyltransferase 2 (arylamine n-acetyltransferase)], GenBank NM_{—}000019 [acetyl-coenzyme a acetyltransferase 1 (acetoacetyl coenzyme a thiolase)], GenBank NM_{—}000051 [ataxia telangiectasia mutated (includes complementation groups a, c and d)], GenBank NM_{—}000104 (cytochrome p450, family 1, subfamily b, polypeptide 1), GenBank NM_{—}000106 (cytochrome p450, family 2, subfamily d, polypeptide 6), GenBank NM_{—}000120 [epoxide hydrolase 1, microsomal (xenobiotic)], GenBank NM_{—}000122 [excision repair cross-complementing rodent repair deficiency, complementation group 3 (xeroderma pigmentosum group b complementing)], GenBank NM_{—}000240 (monoamine oxidase a), GenBank NM_{—}000367 (thiopurine s-methyltransferase), GenBank NM_{—}000379 (xanthine dehydrogenase), GenBank NM_{—}000389 [cyclin-dependent kinase inhibitor 1a (p21, cip1)], GenBank NM_{—}000392 [atp-binding cassette, sub-family c (cftr/mrp), member 2], GenBank NM_{—}000394 (crystallin, alpha a), GenBank NM_{—}000443 [atp-binding cassette, sub-family b (mdr/tap), member 4], GenBank NM_{—}000454 [superoxide dismutase 1, soluble (amyotrophic lateral sclerosis 1 (adult))], GenBank NM_{—}000498 (cytochrome p450, family 11, subfamily b, polypeptide 2), GenBank NM_{—}000499 (cytochrome p450, family 1, subfamily a, polypeptide 1), GenBank NM_{—}000546 [tumor protein p53 (li-fraumeni syndrome)], GenBank NM_{—}000581 (glutathione peroxidase 1), GenBank NM_{—}000594 [tumor necrosis factor (tnf superfamily, member 2)], GenBank NM_{—}000595 [lymphotoxin alpha (tnf superfamily, member 1)], GenBank NM_{—}000636 (superoxide dismutase 2, mitochondrial), GenBank NM_{—}000637 (glutathione reductase), GenBank NM_{—}000639 [fas ligand (tnf superfamily, member 6)], GenBank NM_{—}000662 [n-acetyltransferase 1 (arylamine n-acetyltransferase)], GenBank NM_{—}000754 (catechol-o-methyltransferase), GenBank NM_{—}000755 (carnitine acetyltransferase), GenBank NM_{—}000758 [colony stimulating factor 2 (granulocyte-macrophage)], GenBank NM_{—}000761 (cytochrome p450, family 1, subfamily a, polypeptide 2), GenBank NM_{—}000762 (cytochrome p450, family 2, subfamily a, polypeptide 6), GenBank NM_{—}000767 (cytochrome p450, family 2, subfamily b, polypeptide 6), GenBank NM_{—}000770 (cytochrome p450, family 2, subfamily c, polypeptide 8), GenBank NM_{—}000771 (cytochrome p450, family 2, subfamily c, polypeptide 9), GenBank NM_{—}000773 (cytochrome p450, family 2, subfamily e, polypeptide 1), GenBank NM_{—}000774(cytochrome p450, family 2, subfamily f, polypeptide 1), GenBank NM_{—}000777 (cytochrome p450, family 3, subfamily a, polypeptide 5), GenBank NM_{—}000778 (cytochrome p450, family 4, subfamily a, polypeptide 11), GenBank NM_{—}000779 (cytochrome p450, family 4, subfamily b, polypeptide 1), GenBank NM_{—}000780 (cytochrome p450, family 7, subfamily a, polypeptide 1), GenBank NM_{—}000781 (cytochrome p450, family 11, subfamily a, polypeptide 1), GenBank NM_{—}000782 (cytochrome p450, family 24, subfamily a, polypeptide 1), GenBank NM_{—}000847 (glutathione s-transferase a3), GenBank NM_{—}000848 [glutathione s-transferase m2 (muscle)], GenBank NM_{—}000849 [glutathione s-transferase m3 (brain)], GenBank NM_{—}000851 (glutathione s-transferase m5), GenBank NM_{—}000852 (glutathione s-transferase pi), GenBank NM_{—}000853 (glutathione s-transferase theta 1), GenBank NM_{—}000854 (glutathione s-transferase theta 2), GenBank NM_{—}000896 (cytochrome p450, family 4, subfamily f, polypeptide 3), GenBank NM_{—}000898 (monoamine oxidase b), GenBank NM_{—}000927 [atp-binding cassette, sub-family b(mdr/tap), member 1], GenBank NM_{—}000940 (paraoxonase 3), GenBank NM_{—}000941 [p450 (cytochrome) oxidoreductase], GenBank NM_{—}000962 [prostaglandin-endoperoxide synthase 1 (prostaglandin g/h synthase and cyclooxygenase)], GenBank NM_{—}000963 [prostaglandin-endoperoxide synthase 2 (prostaglandin g/h synthase and cyclooxygenase)], GenBank NM_{—}001055 (sulfotransferase family, cytosolic, 1a, phenol-preferring, member 1), GenBank NM_{—}001056 (sulfotransferase family, cytosolic, 1c, member 1), GenBank NM_{—}001061 [thromboxane a synthase 1 (platelet, cytochrome p450, family 5, subfamily a)]], GenBank NM_{—}001065 (tumor necrosis factor receptor superfamily, member 1a), GenBank NM_{—}001228 (caspase 8, apoptosis-related cysteine peptidase), GenBank NM_{—}001230 (caspase 10, apoptosis-related cysteine peptidase), GenBank NM_{—}001235 [serpin peptidase inhibitor, clade h (heat shock protein 47), member 1, (collagen binding protein 1)), GenBank NM_{—}001512 (glutathione s-transferase a4), GenBank NM_{—}001539 [dnaj (hsp40) homolog, subfamily a, member 1], GenBank NM_{—}001540 (heat shock 27 kda protein 1), GenBank NM_{—}001562 [interleukin 18 (interferon-gamma-inducing factor)], GenBank NM_{—}001565 [chemokine (c-x-c motif) ligand 10], GenBank NM_{—}001609 (acyl-coenzyme a dehydrogenase, short/branched chain), GenBank NM_{—}001746 (calnexin), GenBank NM_{—}001752 (catalase), GenBank NM_{—}001831 (clusterin), GenBank NM_{—}001885 (crystallin, alpha b), GenBank NM_{—}001924 (growth arrest and dna-damage-inducible, alpha), GenBank NM_{—}001931 [dihydrolipoamide s-acetyltransferase (e2 component of pyruvate dehydrogenase complex)], GenBank NM_{—}001964 (early growth response 1), GenBank NM_{—}001979 (epoxide hydrolase 2, cytoplasmic), GenBank NM_{—}001983 [excision repair cross-complementing rodent repair deficiency, complementation group 1 (includes overlapping antisense sequence)], GenBank NM_{—}002021 (flavin containing monooxygenase 1), GenBank NM_{—}002022 (flavin containing monooxygenase 4), GenBank NM_{—}002046 (glyceraldehyde-3-phosphate dehydrogenase), GenBank NM_{—}002083 [glutathione peroxidase 2 (gastrointestinal)], GenBank NM_{—}002133 [heme oxygenase (decycling) 1], GenBank NM_{—}002134 [heme oxygenase (decycling) 2], GenBank NM_{—}002154 (heat shock 70 kda protein 4), GenBank NM_{—}002155 [heat shock 70 kda protein 6 (hsp70b′)], GenBank NM_{—}002157 [heat shock 10 kda protein 1 (chaperonin 10)], GenBank NM_{—}002178 (insulin-like growth factor binding protein 6), GenBank NM_{—}002413 (microsomal glutathione s-transferase 2), GenBank NM_{—}002415 [macrophage migration inhibitory factor (glycosylation-inhibiting factor)], GenBank NM_{—}002452 [nudix (nucleoside diphosphate linked moiety x)-type motif 1], GenBank NM_{—}002574 (peroxiredoxin 1), GenBank NM_{—}002983 [chemokine (c-c motif) ligand 3], GenBank NM_{—}002984 [chemokine (c-c motif) ligand 4], GenBank NM_{—}002989 [chemokine (c-c motif) ligand 21], GenBank NM_{—}003167 [sulfotransferase family, cytosolic, 2a, dehydroepiandrosterone (dhea)-preferring, member 1], GenBank NM_{—}003299 [heat shock protein 90 kda beta (grp94), member 1], GenBank NM_{—}003315 [dnaj (hsp40) homolog, subfamily c, member 7], GenBank NM_{—}003595 (tyrosylprotein sulfotransferase 2), GenBank NM_{—}003596 (tyrosylprotein sulfotransferase 1), GenBank NM_{—}003642 (histone acetyltransferase 1), GenBank NM_{—}003654 [carbohydrate (keratan sulfate gal-6) sulfotransferase 1], GenBank NM_{—}003786 [atp-binding cassette, sub-family c (cftr/mrp), member 3], GenBank NM_{—}003789 (tnfrsf1a-associated via death domain), GenBank NM_{—}003810 [tumor necrosis factor (ligand) superfamily, member 10], GenBank NM_{—}003932 [suppression of tumorigenicity 13 (colon carcinoma) (hsp70 interacting protein)], GenBank NM_{—}003998 [nuclear factor of kappa light polypeptide gene enhancer in b-cells 1 (p105)], GenBank NM_{—}004048 (beta-2-microglobulin), GenBank NM_{—}004050 (bcl2-like 2), GenBank NM_{—}004060 (cyclin g1), GenBank NM_{—}004083 (dna-damage-inducible transcript 3), GenBank NM_{—}004134 [heat shock 70 kda protein 9b (mortalin-2)], GenBank NM_{—}004267 [carbohydrate (n-acetylglucosamine-6-o) sulfotransferase 2], GenBank NM_{—}004273 [carbohydrate (chondroitin 6) sulfotransferase 3], GenBank NM_{—}004323 (bcl2-associated athanogene), GenBank NM_{—}004324 (bcl2-associated x protein), GenBank NM_{—}004343 (calreticulin), GenBank NM_{—}004391 (cytochrome p450, family 8, subfamily b, polypeptide 1), GenBank NM_{—}004528 (microsomal glutathione s-transferase 3), GenBank NM_{—}004605 (sulfotransferase family, cytosolic, 2b, member 1), GenBank NM_{—}004820 (cytochrome p450, family 7, subfamily b, polypeptide 1), GenBank NM_{—}004827 [atp-binding cassette, sub-family g (white), member 2], GenBank NM_{—}004832 (glutathione s-transferase omega 1), GenBank NM_{—}004854 (carbohydrate sulfotransferase 10), GenBank NM_{—}004861 (galactose-3-o-sulfotransferase 1), GenBank NM_{—}004996 [atp-binding cassette, sub-family c (cftr/mrp), member 1], GenBank NM_{—}005053 [rad23 homolog a (s. cerevisiae)], GenBank NM_{—}005147 [dnaj (hsp40) homolog, subfamily a, member 3], GenBank NM_{—}005190 (cyclin c), GenBank NM_{—}005225 (e2f transcription factor 1), GenBank NM_{—}005345 (heat shock 70 kda protein 1a), GenBank NM_{—}005347 [heat shock 70 kda protein 5 (glucose-regulated protein, 78 kda)], GenBank NM_{—}005348 [heat shock protein 90 kda alpha (cytosolic), class a member 1], GenBank NM_{—}005420 (sulfotransferase family le, estrogen-preferring, member 1), GenBank NM_{—}005431 (x-ray repair complementing defective repair in Chinese hamster cells 2), GenBank NM_{—}005526 (heat shock transcription factor 1), GenBank NM_{—}005527 (heat shock 70 kda protein 1-like), GenBank NM_{—}005528 [dnaj (hsp40) homolog, subfamily c, member 4], GenBank NM_{—}005688 [atp-binding cassette, sub-family c (cftr/mrp), member 5], GenBank NM_{—}005732 [rad50 homolog (s. cerevisiae)], GenBank NM_{—}005769 [carbohydrate (n-acetylglucosamine 6-o) sulfotransferase 4], GenBank NM_{—}005809 (peroxiredoxin 2), GenBank NM_{—}005880 [dnaj (hsp40) homolog, subfamily a, member 2], GenBank NM_{—}005952 (metallothionein 1x), GenBank NM_{—}005953 (metallothionein 2a), GenBank NM_{—}005954 [metallothionein 3 (growth inhibitory factor (neurotrophic))], GenBank NM_{—}005998 [chaperonin containing tcp1, subunit 3 (gamma)], GenBank NM_{—}006145 [dnaj (hsp40) homolog, subfamily b, member 1], GenBank NM_{—}006169 (nicotinamide n-methyltransferase), GenBank NM_{—}006308 (heat shock 27 kda protein 3), GenBank NM_{—}006389 (hypoxia up-regulated 1), GenBank NM_{—}006429 [chaperonin containing tcp1, subunit 7 (eta)], GenBank NM_{—}006430 [chaperonin containing tcp1, subunit 4 (delta)], GenBank NM_{—}006431 [chaperonin containing tcp1, subunit 2 (beta)], GenBank NM_{—}006585 [chaperonin containing tcp1, subunit 8 (theta)], GenBank NM_{—}006588 (sulfotransferase family, cytosolic, 1c, member 2), GenBank NM_{—}006597 (heat shock 70 kda protein 8), GenBank NM_{—}006644 (heat shock 105 kda/110 kda protein 1), GenBank NM_{—}006736 [dnaj (hsp40) homolog, subfamily b, member 2], GenBank NM_{—}006895 (histamine n-methyltransferase), GenBank NM_{—}007034 [dnaj (hsp40) homolog, subfamily b, member 4], GenBank NM_{—}007067 (myst histone acetyltransferase 2), GenBank NM_{—}007194 [chk2 checkpoint homolog (s. pombe)], GenBank NM_{—}007326 (cytochrome b5 reductase 3), GenBank NM_{—}007355 [heat shock protein 90 kda alpha (cytosolic), class b member 1], GenBank NM_{—}012073 [chaperonin containing tcp1, subunit 5 (epsilon)], GenBank NM_{—}012126 [carbohydrate (n-acetylglucosamine 6-o) sulfotransferase 5], GenBank NM_{—}012266 [dnaj (hsp40) homolog, subfamily b, member 5], GenBank NM_{—}012328 [dnaj (hsp40) homolog, subfamily b, member 9], GenBank NM_{—}012330 [myst histone acetyltransferase (monocytic leukemia) 4], GenBank NM_{—}012423 (ribosomal protein 113a), GenBank NM_{—}014280 [dnaj (hsp40) homolog, subfamily c, member 8], GenBank NM_{—}014351 (sulfotransferase family 4a, member 1), GenBank NM_{—}014465 (sulfotransferase family, cytosolic, 1b, member 1), GenBank NM_{—}015675 (growth arrest and dna-damage-inducible, beta), GenBank NM_{—}016100 [n-acetyltransferase 5 (ard1 homolog, s. cerevisiae)], GenBank NM_{—}016280(carboxylesterase 4-like), GenBank NM_{—}016306[dnaj(hsp40) homolog, subfamily b, member 11], GenBank NM_{—}017460[cytochrome p450, subfamily iiia(niphedipine oxidase), polypeptide 3], GenBank NM_{—}018602[dnaj(hsp40) homolog, subfamily a, member 4], GenBank NM_{—}019885(cytochrome p450, family 26, subfamily b, polypeptide 1), GenBank NM_{—}019886[carbohydrate(n-acetylglucosamine 6-o) sulfotransferase 7], GenBank NM_{—}020300(microsomal glutathione s-transferase 1), GenBank NM_{—}020529(nuclear factor of kappa light polypeptide gene enhancer in b-cells inhibitor, alpha), GenBank NM_{—}020674(cytochrome p450, family 20, subfamily a, polypeptide 1), GenBank NM_{—}020985(choline acetyltransferase), GenBank NM_{—}021130[peptidylprolyl isomerase a(cyclophilin a)], GenBank NM_{—}021615[carbohydrate(n-acetylglucosamine 6-o) sulfotransferase 6], GenBank NM_{—}021979(heat shock 70 kda protein 2), GenBank NM_{—}022467[carbohydrate(n-acetylgalactosamine 4-0) sulfotransferase 8], GenBank NM_{—}025219[dnaj(hsp40) homolog, subfamily c, member 5], GenBank NM_{—}030752(t-complex 1), GenBank NM_{—}033292[caspase 1, apoptosis-related cysteine peptidase(interleukin 1, beta, convertase)], GenBank NM_{—}053056(cyclin d1), GenBank NM_{—}138578(bcl2-like 1), GenBank NM_{—}139211(homeodomain-only protein), GenBank NM_{—}182649(proliferating cell nuclear antigen).

To screen marker genes for the screening of drugs causing toxicity in human, the present inventors treated drugs causing pulmonary toxicity (Methotrexate, Nitrofurantoin, Amiodarone, or Carbamazepine), teratogenicity (Valproic acid, Thalidomide, or Methotrexate), nephrotoxicity (Cisplatin, Gentamycin, or Amphotericine), mutation [Furylfuramide (AF-2), N-nitroso-N-methylurea (MNU), methylmethanesulfonate (MMS), 4-nitroquinoline-N-oxide (4-NQO), or 2-nitrofluorene (2NF)] and cardiotoxicity (Doxorubicin, or Daunorubicin) to human cell lines (pulmonary toxicity-BEAS-2B; teratogenicity-JEG-3; nephrotoxicity-HK-2; mutation-THLE-3; cardiotoxicity-HUVEC), followed by confirmation of cytotoxicity. As a result, these drugs have been confirmed to cause toxicity in human cells (see Table 2) and based on the test results, effective concentration for the treatment of each drug was determined. Later, each drug was treated to human cell lines at the determined concentration. Then, mRNA was extracted from the drug-treated cell line, followed by synthesis of cDNA. The cDNA was labeled with Cy5 and the control group which was not treated with any drug was labeled with Cy3. Each labeled cDNA was hybridized with toxicity specific human genome oligo microarray (see Table 4), followed by fluoresce image scanning to analyze gene expression patterns. From the analysis, when the ratio of Cy5/Cy3 was more than 1.5 fold, the genes were classified as up-regulated genes, on the contrary when the ratio was up to 0.67 fold, the genes were classified as down-regulated genes. At this time, those genes showing changes in expression pattern at least 1.5 fold by 17 drugs were sub-divided according to the toxicity type (pulmonary toxicity, teratogenicity, nephrotoxicity, mutation and cardio toxicity) (see Table 1). There are no reports saying that those genes are related with toxicity in human cells when the drugs used in this invention have been treated thereto.

TABLE 1

| Toxicity | Drug | Gene No. |
|---|---|---|
| pulmonary | Methotrexate, Nitrofurantoin, | 3 |
| toxicity | Amiodarone & Carbamazepine | |
| | 4 drug Common Genes Down | |
| | Methotrexate, Nitrofurantoin, | 2 |
| | Amiodarone & Carbamazepine | |
| | 4 drug Common Genes up | |
| | 3 drug Common Genes Down | 29 |
| | 3 drug Common Genes up | 8 |
| | Methotrexate | 7 |
| | Nitrofurantoin | 13 |
| | Amiodarone | 6 |
| | Carbamazepine | 5 |
| teratogenicity | 8 drug Common Genes | 13 |
| | Valproic acid, Thalidomide & | 17 |
| | Methotrexate | |
| | 3 drug Common Genes | |
| nephrotoxicity | Cisplatin, Gentamycin, or | 46 |
| | Amphotericine Common Genes | |
| | Down | |
| | Cisplatin, Gentamycin, or | 18 |
| | Amphotericine Common Genes Up | |
| mutation | MMS, 4-NQO, AF-2, MNU, 2-NF | 28 |
| | Common Genes Down | |
| | MMS, 4-NQO, AF-2, MNU, 2-NF | 33 |
| | Common Genes Up | |
| cardio | Doxorubicin & Daunorubicin | 64 |
| toxicity | Common Genes Down | |
| | Doxorubicin & Daunorubicin | 24 |
| | Common Genes Up | |
| general | Tox-Metabolism, Tox-Stress, | 196 |
| toxicity | Tox-Defense | |
| Total | 17 | 512 |

The present invention provides Toxtarget Array which is a DNA microarray for the screening of a drug causing toxicity in human, on which oligonucleotide containing the whole sequence or the part of the gene showing changes in expression pattern by a drug causing pulmonary toxicity, teratogenicity, nephrotoxicity, cardio toxicity, mutation or general toxicity or its complementary sequence is integrated.

The said oligonucleotide or its complementary molecule is preferably composed of 18-30 nucleic acids of the marker gene, and more preferably composed of 20-25 nucleic acids, but not always limited thereto.

The DNA microarray for the screening of a drug causing pulmonary toxicity of the present invention can be constructed by the method well known to those in the art. The method for the construction of the said DNA microarray is as follows:

To immobilize the selected marker gene on DNA chip board as probe DNA, piezoelectric micropipetting or pin spotter is preferably used, but not always limited thereto. In a preferred embodiment of the present invention, pin spotter was used. The DNA microarray board is preferably coated by one of active groups selected from the group consisting of amino-silane, poly-L-lysine and aldehyde, but not always limited thereto. The said board is preferably selected from the group consisting of slide glass, plastic, metal, silicon, nylon and nitrocellulose membrane, but not always limited thereto. In a preferred embodiment of the present invention, slide glass coated with amino-silane was used.

The present invention also provides a screening method of a drug causing toxicity in human using the marker gene of the present invention.

Particularly, the present invention provides a screening method of a drug causing toxicity in human comprising the following steps:

1) treating a sample compound to a human cell line;

2) extracting RNA from the experimental group cells treated with the sample compound of step 1) and from the control group cells not treated with the sample compound;

3) labeling the experimental group cDNA and the control group cDNA with different fluoresceins while synthesizing cDNA from the RNA extracted from the experimental and control groups;

4) hybridizing the cDNA of step 3) each labeled with different fluoresceins with the DNA microarray of the present invention;

5) analyzing the DNA microarray reacted in step 4); and

6) comparing the expression patterns of genes integrated on the DNA microarray of the present invention with that of the control based on the data analyzed in step 5).

In this method, the human cell line of step 1) is preferably selected from the group consisting of BEAS-2B, JEG-3, HK-2, THLE-3 and HUVEC, but not always limited thereto. The fluorescein of step 3) is preferably selected from the group consisting of Cy3, Cy5, poly L-lysine-fluorescein isothiocyanate (FITC), rhodamine-B-isothiocyanate (RITC) and rhodamine, but not always limited thereto and any fluorescein known to those in the art can be used.

In this method, the DNA microarray of step 5) is preferably whole human genome oligo microarray (Agilent, USA), but not always limited thereto and any microarray harboring consistently up-regulated or down-regulated genes of human genome of the present invention on its board can be used (see Table 2 and Table 3). It is most preferred to use the DNA microarray constructed by the present inventors. The analysis in step 5) is preferably performed by using GenePix 4.1 soft ware (Axon Instruments, USA), but not always limited thereto and any analysis soft ware known to those in the art can be used.

In addition, the present invention provides a kit for screening a drug causing toxicity in human containing the DNA microarray of the present invention.

The DNA microarray herein is preferably the one constructed by the method of the present invention, but not always limited thereto.

For the kit for screening, a human cell line preferably selected from the group consisting of BEAS-2B, JEG-3, HK-2, THLE-3 and HUVEC is used, but not always limited thereto.

The kit for screening can additionally include a fluorescein and the fluorescein is preferably selected from the group consisting of streptavidin-like phosphatase conjugate, chemiflurorensce and chemiluminescent, but not always limited thereto.

The kit for screening of the present invention can additionally include a reaction reagent. The reaction reagent can be composed of buffer for hybridization, reverse transcriptase to synthesize cDNA from RNA, cNTPs and rNTP (pre-mix or separated), labeling reagent such as chemical inducer of fluorescent dye, and washing buffer, but not always limited thereto and any reaction reagent for hybridization of DNA microarray, known to those in the art, can be included.

Practical and presently preferred embodiments of the present invention are illustrative as shown in the following Examples, Experimental Examples and Manufacturing Examples.

However, it will be appreciated that those skilled in the art, on consideration of this disclosure, may make modifications and improvements within the spirit and scope of the present invention.

### EXAMPLE 1

### Cell Culture and Treatment of Chemicals

### <1-1> Cell Culture

Human cell lines, BEAS-2B (ATCC, USA), JEG-3 (Korean Cell Line Bank, Korea) and HK-2 (Korean Cell Line Bank, Korea) were cultured in T 75 flask containing DMEM (Gibco-BRL, USA) supplemented with 10% FBS at the concentration of 5×10⁵ cells/ml. THLE-3 cells were cultured in BEGM (Gibco-BRL, USA) supplemented with 10% FBS. HUVEC cells (ATCC, USA) were cultured in T 75 flask containing EGM-2 (CAMBREX, USA) supplemented with 5% FBS at the concentration of 5×10⁵ cells/ml. The present inventors selected 16 kinds of drugs inducing pulmonary toxicity (Methotrexate, Nitrofurantoin, Amiodarone, Carbamazepine), teratogenicity (Valproic acid, Thalidomide, Methotrexate), nephrotoxicity (Cisplatin, Gentamycin, Amphotericine), mutation [Furylfuramide (AF-2), N-nitroso-N-methylurea (MNU), methylmethanesulfonate (MMS), 4-nitroquinoline-N-oxide (4-NQO), 2-nitrofluorene (2NF)] and cardiotoxicity (Doxorubicin, Daunorubicin), which were considered as the most representative toxicity-inducing drugs according to the previous study and reports. Those drugs were dissolved in DMSO and water. The concentration of vehicle was up to 0.1% in every experiment.

### <1-2> Cytotoxicity Test (MTT Assay) and Treatment of Chemicals

MTT assay was performed with BEAS-2B, JEG-3, HK-2, THLE-3 and HUVEC according to the method of Mossman et al (J. Immunol. Methods, 65, 55-63, 1983). The cells (Table 2) in a 24-well plate were treated with each drug dissolved in DMSO or water. 48 hours later, 5 mg/ml of MTT (3-[4,5-dimethylthiazol-2-yl]-2,5-diphenyltetra zolium bromide) was added thereto, followed by culture at 37 for 3 hours. Then, the medium was eliminated and the formed formazan crystal was dissolved in 500 μl of DMSO. The mixture was aliquoted in a 96-well plate and OD₅₄o was measured. Cytotoxicity of the 16 kinds of drugs was measured in each cell line and the results are shown in Table 2.

TABLE 2

| | Cell line | | | | | |
|---|---|---|---|---|---|---|
| | and cell | | Treatment | | | |
| Toxicity | number | Drug | time | Cytotoxicity | Conc. | |
| pulmonary | BEAS-2B; | Methotrexate | 48 h | IC20 | 0.144 | uM |
| toxicity | 3 × 10⁴ | | | | | |
| | cells/well | Nitrofuratoin | | | 89.45 | uM |
| | | Amiodarone | | | 29.388 | uM |
| | | Carbamazepine | | | 324.313 | uM |
| teratogenicity | JEG-3; | Valproic acid | 48 h | IC30 | 7.38 | mM |
| | 3 × 10⁴ | Thalidomide | | | 4.283 | mM |
| | cells/well | Methotrexate | | | 4.75 | mM |
| nephyrotoxicity | HK-2; | Cisplatin | 24 h | IC30 | 8.84 | ug/ml |
| | 2.3 × 10⁴ | Gentamycin | | | 3.44 | mg/ml |
| | cells/well | Amphotericine | | | 4.23 | ug/ml |
| mutation | THLE-3; | Furylfuramide | 3 h | IC20 | 243.12 | uM |
| | 3 × 10⁴ | | | | | |
| | cells/well | N-nitroso-N- | | | 2,093.97 | uM |
| | | methylurea | | | | |
| | | Methylmethanesulfonate | | | 510.37 | uM |
| | | 4-nitroquinoline- | | | 0.83 | uM |
| | | N-oxide | | | | |
| | | 2-nitrofluorene | | | 80.78 | uM |
| cardio | HUVEC; | Doxorubicin | 48 h | IC20 | 82.973 | ng/ml |
| toxicity | 10 × 10⁴ | Daunorubicin | | | 191 | ng/ml |
| | cells/well | | | | | |

(IC20, concentration at which survival is inhibited 20%; IC30, concentration at which survival is inhibited 30%)

Microarray was performed at the above concentrations.

### EXAMPLE 2

### Microarray

<2-1> Separation of Target RNA and Labeling with Fluorescein

Cells were distributed in 100 mm dish, to which each drug was treated at the concentration determined in Example <1-2> for 3, 24 or 48 hours (Table 2). Total RNA was separated from the treated cells by using trizol reagent (Invitrogen Life Technologies, USA) according to the manufacture's instructions, followed by purification using RNeasy mini kit (Qiagen, USA). Genomic DNA was eliminated during RNA purification using RNase-free DNase set (Qiagen, USA). Each total RNA separated above was quantified with a spectrophotometer and purity was confirmed with Agilent 2100 Bioanalyzer (Agilent Technologies, USA).

<2-2> Preparation of Labeled cDNA

For oligo microarray analysis, cDNA was synthesized from the total RNA prepared in Example <2-1>. 30 μg of the total RNA obtained above and 2 μg (1 μg/μl) of oligo (dT) primer were mixed, followed by reaction at 65 for 10 minutes. Annealing was performed in ice right after the reaction. Reagents were prepared as shown in Table 3 for reverse transcription of the annealed RNA.

TABLE 3

| Composition | Volume (μl) |
|---|---|
| 5X first strand buffer | 6 |
| dNTPs | 0.6 |
| 0.1M DDT | 3 |
| SuperScript II enzyme | 3 |
| Cy-3 or Cy-5 dUTP | 2 |

The total RNA separated from the control group was labeled with Cy3-dUTP (green) and the total RNA separated from the experiment group cells treated each drug was labeled with Cy5-dUTP (red). At this time, the two samples were mixed and purified by Microcon YM-30 column (Millipore, USA).

### <2-3> Hybridization

Hybridization and washing were performed by the manufacturer's (GenoCheck, Korea) instructions. Particularly, hybridization was performed in a 62 oven for 12 hours. As a DNA microarray, microarrays shown in Table 4 were used.

TABLE 4

| Toxicity | Microarray |
|---|---|
| pulmonary | 44k Whole Human Genome oligo microarray |
| toxicity | (Agilent, USA) |
| teratogenicity | 44k Whole Human Genome oligo microarray |
| | (Agilent, USA) |
| nephrotoxicity | 35k Whole Human Genome microarray |
| | (Operon, Germany) |
| mutation | 19k Whole Human Genome microarray |
| | (Catholic University, Korea) |
| cardio | 44k Whole Human Genome oligo microarray |
| toxicity | (Agilent, USA) |

After washing (2 minutes with 2×SSC/0.1% SDS, three minutes with 1×SSC, 2 minutes with 0.2×SSC), the slide was dried by centrifugation at 800 rpm for 3 minutes.

### <2-4> Obtainment of Fluorescence Image

Hybridization image on the slide was scanned with Genepix 4000B (Axon Instruments, USA). Fluorescence image of the chip on which non-hybridized genes had been washed out was obtained by using laser fluorescence scanner. Green fluorescence image indicated the activity of gene specifically expressed in the control group and red fluorescence image indicated the activity of gene specifically expressed in the experimental group. Yellow fluorescence image (complementary color of green and red) indicated that there were no big differences in expression between the two groups. Scanned image was analyzed by using GenePix 4.1 software (Axon Instruments, USA) to calculate gene expression rate. From the obtained data, toxicity type-specific marker genes were selected.

Those genes confirmed to be up- or down-regulated at least 1.5 fold by the drug inducing toxicity in human were classified by the type of toxicity (pulmonary toxicity, teratogenicity, nephrotoxicity, mutation and cardiotoxicity) induced. As a result, the genes involved in pulmonary toxicity were 73, the genes involved in teratogenicity were 30, the genes involved in nephrotoxicity were 64, the genes involved in mutation were 61 and the genes involved in cardiotoxicity were 88 (Table 1, and Table 5-Table 10). There have been no such reports proving that those genes are involved in toxicity induced by the treatment of 16 kinds of the drugs used in this invention.

TABLE 5
Genes showing changes in expression by the treatment of a
drug causing pulmonary toxicity

| | Gene | | | |
|---|---|---|---|---|
| Drug | expression | GeneBank | Abbreviation | Gene name |
| 4drug | up | NM_004864 | GDF15 | growth |
| | | | | differentiation |
| | | | | factor 15 |
| 4drug | up | NM_022726 | ELOVL4 | elongation of |
| | | | | very long chain |
| | | | | fatty acids |
| | | | | (fen1/elo2, |
| | | | | sur4/elo3, |
| | | | | yeast)-like 4 |
| 4drug | up | NM_000575 | IL1A | interleukin 1, |
| | | | | alpha |
| 4drug | down | BC052951 | LMNB1 | lamin b1 |
| 4drug | down | NM_207035 | NPD014 | chromosome 1 open |
| | | | | reading frame 63 |
| 3drug | up | AB195679 | FLJ20366 | hypothetical |
| | | | | protein flj20366 |
| 3drug | up | NM_000600 | IL6 | interleukin 6 |
| | | | | (interferon, beta |
| | | | | 2) |
| 3drug | up | NM_013372 | GREM1 | gremlin 1, |
| | | | | cysteine knot |
| | | | | superfamily, |
| | | | | homolog (xenopus |
| | | | | laevis) |
| 3drug | up | NM_014707 | HDAC9 | histone |
| | | | | deacetylase 9 |
| 3drug | up | BC053653 | CXCL2 | chemokine (c-x-c |
| | | | | motif) ligand 2 |
| 3drug | up | AY247738 | TRIB3 | tribbles homolog |
| | | | | 3 (drosophila) |
| 3drug | up | NM_000189 | HK2 | hexokinase 2 |
| 3drug | up | X96753 | CSPG4 | chondroitin |
| | | | | sulfate |
| | | | | proteoglycan 4 |
| | | | | (melanoma- |
| | | | | associated) |
| 3drug | down | A_24_P349756 | | |
| 3drug | down | NM_002305 | LGALS1 | lectin, |
| | | | | galactoside- |
| | | | | binding, soluble, |
| | | | | 1 (galectin 1) |
| 3drug | down | AY367065 | ASPM | hypothetical |
| | | | | protein flj10517 |
| 3drug | down | NM_006464 | TGOLN2 | trans-golgi |
| | | | | network protein 2 |
| 3drug | down | BC065544 | C14orf106 | putative protein |
| | | | | p243 which |
| | | | | interacts with |
| | | | | transcription |
| | | | | factor sp1 |
| 3drug | down | D63880 | CNAP1 | chromosome |
| | | | | condensation- |
| | | | | related smc- |
| | | | | associated |
| | | | | protein 1 |
| 3drug | down | NM_012338 | TM4SF12 | tetraspanin 12 |
| 3drug | down | NM_004293 | GDA | guanine deaminase |
| 3drug | down | NM_000641 | IL11 | interleukin 11 |
| 3drug | down | AK024898 | | |
| 3drug | down | NM_001295 | CCR1 | chemokine (c-c |
| | | | | motif) receptor 1 |
| 3drug | down | AF289615 | | hypothetical |
| | | | | protein |
| 3drug | down | AL832445 | FLJ25770 | hypothetical |
| | | | | protein flj25770 |
| 3drug | down | NM_134470 | IL1RAP | interleukin 1 |
| | | | | receptor |
| | | | | accessory protein |
| 3drug | down | NM_198187 | ASTN2 | astrotactin 2 |
| 3drug | down | NM_001001958 | OR7G3 | olfactory |
| | | | | receptor, family |
| | | | | 7, subfamily g, |
| | | | | member 3 |
| 3drug | down | M92424 | MDM2 | mdm2, transformed |
| | | | | 3t3 cell double |
| | | | | minute 2, p53 |
| | | | | binding protein |
| | | | | (mouse) |
| 3drug | down | NM_199511 | URB | steroid sensitive |
| | | | | gene 1 |
| 3drug | down | NM_030754 | SAA2 | serum amyloid a2 |
| 3drug | down | BG564669 | SAA1 | serum amyloid a1 |
| 3drug | down | NM_007371 | BRD3 | bromodomain |
| | | | | containing 3 |
| 3drug | down | BX648583 | EDIL3 | egf-like repeats |
| | | | | and discoidin i- |
| | | | | like domains 3 |
| 3drug | down | NM_002260 | KLRC3 | killer cell |
| | | | | lectin-like |
| | | | | receptor |
| | | | | subfamily c, |
| | | | | member 2 |
| 3drug | down | AL832142 | TM7SF1 | g protein-coupled |
| | | | | receptor 137b |
| 3drug | down | AB044088 | BHLHB3 | basic helix-loop- |
| | | | | helix domain |
| | | | | containing, class |
| | | | | b, 3 |
| 3drug | down | CR936799 | FHL2 | four and a half |
| | | | | lim domains 2 |
| 3drug | down | NM_001025077 | CUGBP2 | cug triplet |
| | | | | repeat, rna |
| | | | | binding protein 2 |
| 3drug | down | AK125636 | GLRX | glutaredoxin |
| | | | | (thioltransferase) |
| 3drug | down | D26122 | ZFM1 | splicing factor 1 |
| AM | | BE300829 | PLK1 | |
| AM | | BC043371 | GFI1B | growth factor |
| | | | | independent 1b |
| | | | | (potential |
| | | | | regulator of |
| | | | | cdkn1a, |
| | | | | translocated in |
| | | | | cml) |
| AM | | NM_004265 | FADS2 | fatty acid |
| | | | | desaturase 2 |
| AM | | NM_014391 | ANKRD1 | ankyrin repeat |
| | | | | domain 1 (cardiac |
| | | | | muscle) |
| AM | | BM918324 | LY96 | lymphocyte |
| | | | | antigen 96 |
| AM | | BC065304 | DEPDC1 | dep domain |
| | | | | containing 1 |
| CBZ | | NM_001734 | C1S | complement |
| | | | | component 1, s |
| | | | | subcomponent |
| CBZ | | AK124635 | PCSK9 | proprotein |
| | | | | convertase |
| | | | | subtilisin/kexin |
| | | | | type 9 |
| CBZ | | NM_001733 | C1R | complement |
| | | | | component 1, r |
| | | | | subcomponent |
| CBZ | | BG564326 | SAA4 | serum amyloid a4, |
| | | | | constitutive |
| CBZ | | AK095849 | snord22 | major |
| | | | | histocompatibility |
| | | | | complex, class |
| | | | | i, a |
| MTX | | BU845177 | RAC1 | ras-related c3 |
| | | | | botulinum toxin |
| | | | | substrate 1 (rho |
| | | | | family, small gtp |
| | | | | binding protein |
| | | | | rac1) |
| MTX | | NM_004759 | MAPKAPK2 | mitogen-activated |
| | | | | protein kinase- |
| | | | | activated protein |
| | | | | kinase 2 |
| MTX | | BC031405 | DUSP10 | dual specificity |
| | | | | phosphatase 10 |
| MTX | | AK027210 | DUSP14 | dual specificity |
| | | | | phosphatase 14 |
| MTX | | AK131071 | SLC31A2 | solute carrier |
| | | | | family 31 (copper |
| | | | | transporters), |
| | | | | member 2 |
| MTX | | AK127679 | DUSP1 | dual specificity |
| | | | | phosphatase 1 |
| MTX | | BC008678 | IL1B | interleukin 1, |
| | | | | beta |
| NF | | NM_000944 | PPP3CA | protein |
| | | | | phosphatase 3 |
| | | | | (formerly 2b), |
| | | | | catalytic |
| | | | | subunit, alpha |
| | | | | isoform |
| | | | | (calcineurin a |
| | | | | alpha) |
| NF | | AA995107 | IL-7R | interleukin 7 |
| | | | | receptor |
| NF | | NM_172220 | CSF3 | colony |
| | | | | stimulating |
| | | | | factor 3 |
| | | | | (granulocyte) |
| NF | | AK098095 | BRAF | v-raf murine |
| | | | | sarcoma viral |
| | | | | oncogene homolog |
| | | | | b1 |
| NF | | NM_139314 | ANGPTL4 | angiopoietin-like 4 |
| NF | | BC021552 | CACNG6 | calcium channel, |
| | | | | voltage- |
| | | | | dependent, gamma |
| | | | | subunit 6 |
| NF | | NM_003955 | SOCS3 | suppressor of |
| | | | | cytokine |
| | | | | signaling 3 |
| NF | | NM_003629 | PIK3R3 | phosphoinositide- |
| | | | | 3-kinase, |
| | | | | regulatory |
| | | | | subunit 3 (p55, |
| | | | | gamma) |
| NF | | BM906235 | ID3 | inhibitor of dna |
| | | | | binding 3, |
| | | | | dominant negative |
| | | | | helix-loop-helix |
| | | | | protein |
| NF | | CR618407 | BMP2 | bone |
| | | | | morphogenetic |
| | | | | protein 2 |
| NF | | CR614015 | CD14 | cd14 antigen |
| NF | | U68019 | SMAD3 | smad, mothers |
| | | | | against dpp |
| | | | | homolog 3 |
| | | | | (drosophila) |
| NF | | BC069137 | IL5 | interleukin 5 |
| | | | | (colony- |
| | | | | stimulating |
| | | | | factor, |
| | | | | eosinophil) |

(AM: Amiodarone; CBZ: Carbamazepine; MTX: Methotrexate; NF: Nitrofurantoin)

TABLE 6
Genes showing changes in expression by the treatment of a
drug causing teratogenicity

| | | Gene | | | |
|---|---|---|---|---|---|
| Drug | Coexpression | expression | GeneBank | Abbreviation | Gene name |
| 8drug | common | up | AB209845 | TTF2 | transcription |
| | | | | | termination |
| | | | | | factor, rna |
| | | | | | polymerase ii |
| | | | | | variant |
| | common | up | AF001893 | TncRNA | trophoblast- |
| | | | | | derived noncoding |
| | | | | | rna |
| | common | up | AK001879 | FLJ11017 | hypothetical |
| | | | | | protein flj11017 |
| | common | up | AK023571 | CYP19A1 | zinc finger |
| | | | | | protein 100 |
| | common | up | AK122757 | TUBB3 | melanocortin 1 |
| | | | | | receptor (alpha |
| | | | | | melanocyte |
| | | | | | stimulating |
| | | | | | hormone receptor) |
| | common | up | AK125877 | MGC27016 | hypothetical |
| | | | | | protein mgc27016 |
| | common | up | BC042755 | RGS2 | regulator of g- |
| | | | | | protein signalling |
| | | | | | 2, 24 kda |
| | common | up | BC063830 | SIAT7A | st6 (alpha-n- |
| | | | | | acetyl-neuraminyl- |
| | | | | | 2,3-beta- |
| | | | | | galactosyl-1,3)-n- |
| | | | | | acetylgalactosaminide |
| | | | | | alpha-2,6- |
| | | | | | sialyltransferase 1 |
| | common | up | BX649112 | COBLL1 | cobl-like 1 |
| | common | up | NM_004155 | SERPINB9 | serpin peptidase |
| | | | | | inhibitor, clade b |
| | | | | | (ovalbumin), |
| | | | | | member 9 |
| | common | up | NM_181659 | NCOA3 | nuclear receptor |
| | | | | | coactivator 3 |
| | common | down | BX648021 | B7-H4 | v-set domain |
| | | | | | containing t cell |
| | | | | | activation |
| | | | | | inhibitor 1 |
| | common | down | XM_031553 | SR140 | u2-associated |
| | | | | | sr140 protein |
| 3drug | common | up | AB018258 | ATP10B | ATPase, class v, |
| (VA, | | | | | type 10b |
| Thal, | common | up | AK023574 | SLC40A1 | zinc finger rna |
| MTX) | | | | | binding protein |
| | common | up | AK057515 | | |
| | common | up | AK095632 | ABTB2 | ankyrin repeat and |
| | | | | | btb (poz) domain |
| | | | | | containing 2 |
| | common | up | AK126731 | GLCCI1 | islet cell |
| | | | | | autoantigen 1, |
| | | | | | 69 kda |
| | common | up | BC036890 | TFCP2L4 | grainyhead-like 3 |
| | | | | | (drosophila) |
| | common | up | BX111592 | | |
| | common | up | NM_000735 | CGA | glycoprotein |
| | | | | | hormones, alpha |
| | | | | | polypeptide |
| | common | up | NM_001003793 | RBMS3 | RNA binding motif, |
| | | | | | single stranded |
| | | | | | interacting |
| | | | | | protein |
| | common | up | NM_002356 | MARCKS | myristoylated |
| | | | | | alanine-rich |
| | | | | | protein kinase c |
| | | | | | substrate |
| | common | up | NM_004615 | TM4SF2 | tetraspanin 7 |
| | common | up | NM_005668 | SIAT8D | st8 alpha-n- |
| | | | | | acetyl-neuraminide |
| | | | | | alpha-2,8- |
| | | | | | sialyltransferase 4 |
| | common | up | NM_018018 | SLC38A4 | solute carrier |
| | | | | | family 38, member 4 |
| | common | up | Y18483 | SLC7A8 | solute carrier |
| | | | | | family 7 (cationic |
| | | | | | amino acid |
| | | | | | transporter, y+ |
| | | | | | system), member 8 |
| | common | down | NM_001618 | PARP1 | poly (adp-ribose) |
| | | | | | polymerase family, |
| | | | | | member 1 |
| | common | down | NM_024342 | GRLF1 | glucocorticoid |
| | | | | | receptor dna |
| | | | | | binding factor 1 |
| | common | down | NM_032484 | LGP1 | homolog of mouse |
| | | | | | lgp1 |

(VA: Valproic acid; Thal: Thalidomide; MTX: Methotrexate)

TABLE 7
Genes showing changes in expression by the treatment of a
drug causing nephrotoxicity

| | | Gene | | | |
|---|---|---|---|---|---|
| Drug | Coexpression | expression | GeneBank | Abbreviation | Gene name |
| 3drug | common | up | AJ002535 | OBSCN | hypothetical |
| | | | | | protein flj14124 |
| | common | up | AK001361 | PPP1R15A | protein |
| | | | | | phosphatase 1, |
| | | | | | regulatory |
| | | | | | (inhibitor) |
| | | | | | subunit 15a |
| | common | up | AK025974 | MGC2574 | hypothetical |
| | | | | | protein mgc2574 |
| | common | up | AK026909 | SAS10 | disrupter of |
| | | | | | silencing 10 |
| | common | up | AK074052 | TRIM41 | tripartite motif- |
| | | | | | containing 41 |
| | common | up | AK095253 | BYSL | bystin-like |
| | common | up | BC040191 | SLC35E4 | solute carrier |
| | | | | | family 35, member |
| | | | | | e4 |
| | common | up | BC067751 | MAFF | v-maf |
| | | | | | musculoaponeurotic |
| | | | | | fibrosarcoma |
| | | | | | oncogene homolog f |
| | | | | | (avian) |
| | common | up | BM555452 | TNFRSF12A | tumor necrosis |
| | | | | | factor receptor |
| | | | | | superfamily, |
| | | | | | member 12a |
| | common | up | BU673968 | RIOK3 | rio kinase 3 |
| | | | | | (yeast) |
| | common | up | CR601067 | PLAUR | plasminogen |
| | | | | | activator, |
| | | | | | urokinase receptor |
| | common | up | CR613579 | GADD45G | growth arrest and |
| | | | | | dna-damage- |
| | | | | | inducible, gamma |
| | common | up | D67025 | PSMD3 | proteasome |
| | | | | | (prosome, |
| | | | | | macropain) 26s |
| | | | | | subunit, non- |
| | | | | | atpase, 3 |
| | common | up | NM_015946 | PELO | pro1770 protein |
| | common | up | NM_031298 | MGC2963 | transmembrane |
| | | | | | protein 93 |
| | common | up | NM_138417 | MGC20419 | kti12 homolog, |
| | | | | | chromatin |
| | | | | | associated (s. cerevisiae) |
| | common | up | NM_152392 | AHSA2 | aha1, activator of |
| | | | | | heat shock 90 kda |
| | | | | | protein atpase |
| | | | | | homolog 2 (yeast) |
| | common | up | XM_039495 | D15Wsu75e | |
| | common | down | AB018270 | MYO1D | myosin id |
| | common | down | AB040955 | KIAA1522 | kiaa1522 |
| | common | down | AB075871 | FLJ42654 | hypothetical |
| | | | | | protein hmfn1187 |
| | common | down | AF097935 | DSG1 | desmoglein 1 |
| | common | down | AF279145 | ANTXR1 | tumor endothelial |
| | | | | | marker 8 |
| | common | down | AF307451 | CECR6 | cat eye syndrome |
| | | | | | chromosome region, |
| | | | | | candidate 6 |
| | common | down | AK023662 | C9orf44 | chromosome 9 open |
| | | | | | reading frame 44 |
| | common | down | AK024144 | FLJ14082 | hypothetical |
| | | | | | protein flj14082 |
| | common | down | AK094580 | STK32A | serine/threonine |
| | | | | | kinase 32a |
| | common | down | AK096265 | FLJ10052 | sushi domain |
| | | | | | containing 4 |
| | common | down | AK096289 | THSD1 | thrombospondin, |
| | | | | | type i, domain |
| | | | | | containing 1 |
| | common | down | AK122912 | ZGPAT | lck interacting |
| | | | | | transmembrane |
| | | | | | adaptor 1 |
| | common | down | AL136662 | DKFZP564O1664 | chromosome 15 open |
| | | | | | reading frame 44 |
| | common | down | AL833764 | FER1L4 | fer-1-like 4 (c. elegans) |
| | common | down | AY008294 | ZNFN1A2 | zinc finger |
| | | | | | protein, subfamily |
| | | | | | 1a, 2 (helios) |
| | common | down | AY129013 | TBC1D17 | tbc1 domain |
| | | | | | family, member 17 |
| | common | down | AY203954 | RBM3 | rna binding motif |
| | | | | | (rnp1, rrm) |
| | | | | | protein 3 |
| | common | down | AY358993 | KRTCAP3 | keratinocyte |
| | | | | | associated protein 3 |
| | common | down | AY706204 | SIN3B | sin3 homolog b, |
| | | | | | transcription |
| | | | | | regulator (yeast) |
| | common | down | BC004102 | ALDH3A1 | aldehyde |
| | | | | | dehydrogenase 3 |
| | | | | | family, membera1 |
| | common | down | BC025741 | FLJ35681 | chromosome 16 open |
| | | | | | reading frame 54 |
| | common | down | BC033515 | MGC35274 | lysm, putative |
| | | | | | peptidoglycan- |
| | | | | | binding, domain |
| | | | | | containing 2 |
| | common | down | BC051890 | TUBG2 | tubulin, gamma 2 |
| | common | down | BC073828 | PPP2CZ | protein |
| | | | | | phosphatase 1j |
| | | | | | (pp2c domain |
| | | | | | containing) |
| | common | down | BE889572 | IFRG28 | receptor |
| | | | | | transporter |
| | | | | | protein 4 |
| | common | down | BM542003 | FLJ12953 | wd repeat domain |
| | | | | | 54 |
| | common | down | BX537620 | HMGCS1 | 3-hydroxy-3- |
| | | | | | methylglutaryl- |
| | | | | | coenzyme a |
| | | | | | synthase 1 |
| | | | | | (soluble) |
| | common | down | BX640959 | FLJ14213 | hypothetical |
| | | | | | protein flj14213 |
| | common | down | NM_000134 | FABP2 | fatty acid binding |
| | | | | | protein 2, |
| | | | | | intestinal |
| | common | down | NM_001001524 | TM6SF2 | transmembrane 6 |
| | | | | | superfamily member 2 |
| | common | down | NM_001004703 | OR4C46 | olfactory |
| | | | | | receptor, family |
| | | | | | 4, subfamily c, |
| | | | | | member 46 |
| | common | down | NM_001005190 | OR7A10 | olfactory |
| | | | | | receptor, family |
| | | | | | 7, subfamily a, |
| | | | | | member 10 |
| | common | down | NM_001010867 | LOC200205 | chromosome 1 open |
| | | | | | reading frame 69 |
| | common | down | NM_001215 | CA6 | carbonic anhydrase |
| | | | | | vi |
| | common | down | NM_002409 | MGAT3 | mannosyl (beta- |
| | | | | | 1,4-)-glycoprotein |
| | | | | | beta-1,4-n- |
| | | | | | acetylglucosaminyl |
| | | | | | transferase |
| | common | down | NM_002918 | RFX1 | regulatory factor |
| | | | | | x, 1 (influences |
| | | | | | hla class ii |
| | | | | | expression) |
| | common | down | NM_005203 | COL13A1 | collagen, type |
| | | | | | xiii, alpha 1 |
| | common | down | NM_005247 | FGF3 | fibroblast growth |
| | | | | | factor 3 (murine |
| | | | | | mammary tumor |
| | | | | | virus integration |
| | | | | | site (v-int-2) |
| | | | | | oncogene homolog) |
| | common | down | NM_005310 | GRB7 | growth factor |
| | | | | | receptor-bound |
| | | | | | protein 7 |
| | common | down | NM_012110 | CHIC2 | cysteine-rich |
| | | | | | hydrophobic domain 2 |
| | common | down | NM_014323 | ZNF278 | zinc finger |
| | | | | | protein 278 |
| | common | down | NM_020458 | TTC7A | tetratricopeptide |
| | | | | | repeat domain 7a |
| | common | down | NM_080542 | COLQ | collagen-like tail |
| | | | | | subunit (single |
| | | | | | strand of |
| | | | | | homotrimer) of |
| | | | | | asymmetric |
| | | | | | acetylcholinesterase |
| | common | down | NM_145202 | PRAP1 | proline-rich |
| | | | | | acidic protein 1 |
| | common | down | NM_173160 | FXYD4 | fxyd domain |
| | | | | | containing ion |
| | | | | | transport |
| | | | | | regulator 4 |
| | common | down | XM_290629 | C14orf78 | chromosome 14 open |
| | | | | | reading frame 78 |

(3 drug: Cisplatin, Gentamycin and Amphotericine)

TABLE 8
Genes showing changes in expression by the treatment of a
drug causing mutation

| | | Gene | | | |
|---|---|---|---|---|---|
| Drug | Coexpression | expression | GeneBank | Abbreviation | Gene name |
| 5drug | common | up | AB020695 | KIAA0888 | kiaa0888 protein |
| | common | up | AF134401 | ESPN | espin |
| | common | up | AF205437 | GIG2 | tribbles homolog 1 |
| | | | | | (drosophila) |
| | common | up | AF211977 | LENG10 | leukocyte receptor |
| | | | | | cluster (lrc) |
| | | | | | member 10 |
| | common | up | AJ001348 | LY6K | lymphocyte antigen |
| | | | | | 6 complex, locus k |
| | common | up | AK024433 | MRPS25 | mitochondrial |
| | | | | | ribosomal protein |
| | | | | | s25 |
| | common | up | AK024448 | | cxyorf1-related |
| | | | | | protein |
| | common | up | AK027024 | TCEA3 | transcription |
| | | | | | elongation factor |
| | | | | | a (sii), 3 |
| | common | up | BE887356 | MRPL9 | mitochondrial |
| | | | | | ribosomal protein |
| | | | | | 19 |
| | common | up | L32786 | SLC25A5 | solute carrier |
| | | | | | family 25 |
| | | | | | (mitochondrial |
| | | | | | carrier; adenine |
| | | | | | nucleotide |
| | | | | | translocator), |
| | | | | | member 5 |
| | common | up | M26147 | DNTT | deoxynucleotidyltransferase, |
| | | | | | terminal |
| | common | up | NM_000339 | SLC12A3 | solute carrier |
| | | | | | family 12 |
| | | | | | (sodium/chloride |
| | | | | | transporters), |
| | | | | | member 3 |
| | common | up | NM_001171 | ABCC6 | atp-binding |
| | | | | | cassette, sub- |
| | | | | | family c |
| | | | | | (cftr/mrp), member 6 |
| | common | up | NM_001337 | CX3CR1 | chemokine (c—x3—c |
| | | | | | motif) receptor 1 |
| | common | up | NM_001643 | APOA2 | apolipoprotein a- |
| | | | | | ii |
| | common | up | NM_001647 | APOD | apolipoprotein d |
| | common | up | NM_001711 | BGN | biglycan |
| | common | up | NM_001936 | DPP6 | dipeptidyl- |
| | | | | | peptidase 6 |
| | common | up | NM_001951 | E2F5 | e2f transcription |
| | | | | | factor 5, p130- |
| | | | | | binding |
| | common | up | NM_001974 | EMR1 | egf-like module |
| | | | | | containing, mucin- |
| | | | | | like, hormone |
| | | | | | receptor-like 1 |
| | common | up | NM_002309 | LIF | leukemia |
| | | | | | inhibitory factor |
| | | | | | (cholinergic |
| | | | | | differentiation |
| | | | | | factor) |
| | common | up | NM_003722 | TP73L | tumor protein p73- |
| | | | | | like |
| | common | up | NM_004310 | RHOH | ras homolog gene |
| | | | | | family, member h |
| | common | up | NM_004519 | KCNQ3 | potassium voltage- |
| | | | | | gated channel, |
| | | | | | kqt-like |
| | | | | | subfamily, member 3 |
| | common | up | NM_005461 | MAFB | v-maf |
| | | | | | musculoaponeurotic |
| | | | | | fibrosarcoma |
| | | | | | oncogene homolog b |
| | | | | | (avian) |
| | common | up | NM_005510 | DOM3Z | dom-3 homolog z |
| | | | | | (c. elegans) |
| | common | up | NM_006495 | EVI2B | ecotropic viral |
| | | | | | integration site |
| | | | | | 2b |
| | common | up | NM_006940 | SOX5 | sry (sex |
| | | | | | determining region |
| | | | | | y)-box 5 |
| | common | up | NM_007267 | TMC6 | transmembrane |
| | | | | | channel-like 6 |
| | common | up | NM_012190 | ALDH1L1 | aldehyde |
| | | | | | dehydrogenase 1 |
| | | | | | family, member 11 |
| | common | up | NM_017753 | PRG-3 | plasticity related |
| | | | | | gene 3 |
| | common | up | NM_018199 | EXDL2 | exonuclease 3′-5′ |
| | | | | | domain-like 2 |
| | common | up | NM_018659 | CYTL1 | cytokine-like 1 |
| | common | down | AB014541 | AATK | apoptosis- |
| | | | | | associated |
| | | | | | tyrosine kinase |
| | common | down | AF000562 | UPK2 | uroplakin 2 |
| | common | down | AF118072 | | Protein |
| | | | | | phosphatase |
| | | | | | methylesterase-1 |
| | common | down | AF210651 | NAG18 | nag18 |
| | common | down | AJ008151 | MAP3K14 | mitogen-activated |
| | | | | | protein kinase |
| | | | | | kinase kinase 14 |
| | common | down | J03048 | HPX | hemopexin |
| | common | down | M26747 | THRB | thyroid hormone |
| | | | | | receptor, beta |
| | | | | | (erythroblastic |
| | | | | | leukemia viral (v- |
| | | | | | erb-a) oncogene |
| | | | | | homolog 2, avian) |
| | common | down | M81768 | SLC9A1 | solute carrier |
| | | | | | family 9 |
| | | | | | (sodium/hydrogen |
| | | | | | exchanger), member |
| | | | | | 1 (antiporter, |
| | | | | | na+/h+, amiloride |
| | | | | | sensitive) |
| | common | down | NM_000356 | TCOF1 | treacher collins- |
| | | | | | franceschetti |
| | | | | | syndrome 1 |
| | common | down | NM_000715 | C4BPA | complement |
| | | | | | component 4 |
| | | | | | binding protein, |
| | | | | | alpha |
| | common | down | NM_001141 | ALOX15B | arachidonate 15- |
| | | | | | lipoxygenase, type b |
| | common | down | NM_001683 | ATP2B2 | atpase, ca++ |
| | | | | | transporting, |
| | | | | | plasma membrane 2 |
| | common | down | NM_001783 | CD79A | cd79a antigen |
| | | | | | (immunoglobulin- |
| | | | | | associated alpha) |
| | common | down | NM_003371 | VAV2 | vav 2 oncogene |
| | common | down | NM_003394 | WNT10B | wingless-type mmtv |
| | | | | | integration site |
| | | | | | family, member 10b |
| | common | down | NM_003641 | IFITM1 | interferon induced |
| | | | | | transmembrane |
| | | | | | protein 1 (9-27) |
| | common | down | NM_006399 | BATF | basic leucine |
| | | | | | zipper |
| | | | | | transcription |
| | | | | | factor, atf-like |
| | common | down | NM_014081 | PRO0297 | |
| | common | down | NM_014151 | HSPC053 | |
| | common | down | NM_014509 | SERHL2 | kraken-like |
| | common | down | NM_015900 | PLA1A | phospholipase a1 |
| | | | | | member a |
| | common | down | NM_015950 | MRPL2 | mitochondrial |
| | | | | | ribosomal protein |
| | | | | | l2 |
| | common | down | NM_016356 | DCDC2 | doublecortin |
| | | | | | domain containing 2 |
| | common | down | S49432 | COL6A3 | collagen, type vi, |
| | | | | | alpha 3 |
| | common | down | S72620 | FLI1 | ews-fli1 protein |
| | common | down | X52339 | KOX8 | zinc finger |
| | | | | | protein 708 (kox8) |
| | common | down | X99631 | HOXC12 | homeobox c12 |
| | common | down | Z36807 | MAML3 | mastermind-like 3 |
| | | | | | (drosophila) |

(5 drug: Furylfuramide; N-nitroso-N-methylurea; methylmethanesulfonate; 4-nitroquinoline-N-oxide; and 2-nitrofluorene)

TABLE 9
Genes showing changes in expression by the treatment of a
drug causing cardiotoxicity

| | | Gene | | | |
|---|---|---|---|---|---|
| Drug | Coexpression | expression | GeneBank | Abbreviation | Gene name |
| 2drug | common | up | AB209032 | ATF3 | activating |
| | | | | | transcription |
| | | | | | factor 3 |
| | common | up | AF023676 | TM7SF2 | transmembrane 7 |
| | | | | | superfamily member 2 |
| | common | up | AF033122 | SESN1 | sestrin 1 |
| | common | up | AF332558 | BBC3 | bcl2 binding |
| | | | | | component 3 |
| | common | up | AK055797 | PTE2B | acyl-coa |
| | | | | | thioesterase 4 |
| | common | up | AY123223 | SESN2 | sestrin 2 |
| | common | up | BC003684 | CXADR | coxsackie virus |
| | | | | | and adenovirus |
| | | | | | receptor |
| | common | up | BC021008 | CYFIP2 | |
| | common | up | BC060797 | PARD6G | par-6 partitioning |
| | | | | | defective 6 |
| | | | | | homolog gamma (c. elegans) |
| | common | up | BC063416 | PLA2G4C | phospholipase a2, |
| | | | | | group ivc |
| | | | | | (cytosolic, |
| | | | | | calcium- |
| | | | | | independent) |
| | common | up | CR590366 | MDK | midkine (neurite |
| | | | | | growth-promoting |
| | | | | | factor 2) |
| | common | up | CR623038 | ID2 | inhibitor of dna |
| | | | | | binding 2, |
| | | | | | dominant negative |
| | | | | | helix-loop-helix |
| | | | | | protein |
| | common | up | NM_001024807 | APLP1 | amyloid beta (a4) |
| | | | | | precursor-like |
| | | | | | protein 1 |
| | common | up | NM_001759 | CCND2 | cyclin d2 |
| | common | up | NM_003326 | TNFSF4 | tumor necrosis |
| | | | | | factor (ligand) |
| | | | | | superfamily, |
| | | | | | member 4 (tax- |
| | | | | | transcriptionally |
| | | | | | activated |
| | | | | | glycoprotein 1, |
| | | | | | 34 kda) |
| | common | up | NM_003512 | HIST1H2AC | |
| | common | up | NM_003620 | PPM1D | protein |
| | | | | | phosphatase 1d |
| | | | | | magnesium- |
| | | | | | dependent, delta |
| | | | | | isoform |
| | common | up | NM_005532 | IFI27 | interferon, alpha- |
| | | | | | inducible protein |
| | | | | | 27 |
| | common | up | NM_019089 | HES2 | |
| | common | up | NM_021101 | CLDN1 | claudin 1 |
| | common | up | NM_024430 | PSTPIP2 | proline-serine- |
| | | | | | threonine |
| | | | | | phosphatase |
| | | | | | interacting |
| | | | | | protein 2 |
| | common | up | NM_032387 | WNK4 | wnk lysine |
| | | | | | deficient protein |
| | | | | | kinase 4 |
| | common | up | NM_058229 | FBXO32 | |
| | common | up | NM_144586 | LYPDC1 | |
| | common | down | AB208912 | GBP1 | guanylate binding |
| | | | | | protein 1, |
| | | | | | interferon- |
| | | | | | inducible, 67 kda |
| | common | down | AB209019 | RGS4 | regulator of g- |
| | | | | | protein signalling 4 |
| | common | down | AB209172 | SLC6A6 | solute carrier |
| | | | | | family 6 |
| | | | | | (neurotransmitter |
| | | | | | transporter, |
| | | | | | taurine), member 6 |
| | common | down | AB209660 | CD40 | cd40 antigen (tnf |
| | | | | | receptor |
| | | | | | superfamily member |
| | | | | | 5) |
| | common | down | AB210026 | MYH10 | myosin, heavy |
| | | | | | polypeptide 10, |
| | | | | | non-muscle |
| | common | down | AF045459 | BMX | bmx non-receptor |
| | | | | | tyrosine kinase |
| | common | down | AF053305 | BUB1 | bub1 budding |
| | | | | | uninhibited by |
| | | | | | benzimidazoles 1 |
| | | | | | homolog (yeast) |
| | common | down | AF053306 | BUB1B | bub1 budding |
| | | | | | uninhibited by |
| | | | | | benzimidazoles 1 |
| | | | | | homolog beta |
| | | | | | (yeast) |
| | common | down | AI185409 | CKS1B | |
| | common | down | AK024292 | SGOL1 | |
| | common | down | AK056803 | H2AFZ | h2a histone |
| | | | | | family, member z |
| | common | down | AK074377 | UHRF1 | ubiquitin-like, |
| | | | | | containing phd and |
| | | | | | ring finger |
| | | | | | domains, 1 |
| | common | down | AK091170 | CDKN2C | cyclin-dependent |
| | | | | | kinase inhibitor |
| | | | | | 2c (p18, inhibits |
| | | | | | cdk4) |
| | common | down | AK122902 | TGFB3 | transforming |
| | | | | | growth factor, |
| | | | | | beta 3 |
| | common | down | AK123010 | RRM2 | ribonucleotide |
| | | | | | reductase m2 |
| | | | | | polypeptide |
| | common | down | AL833741 | ENO1 | enolase 1, (alpha) |
| | common | down | AY358868 | TNFSF18 | tumor necrosis |
| | | | | | factor (ligand) |
| | | | | | superfamily, |
| | | | | | member 18 |
| | common | down | AY750055 | DIAPH3 | diaphanous homolog |
| | | | | | 3 (drosophila) |
| | common | down | BC032677 | UBE2C | ubiquitin- |
| | | | | | conjugating enzyme |
| | | | | | e2c |
| | common | down | BC035407 | IL3RA | interleukin 3 |
| | | | | | receptor, alpha |
| | | | | | (low affinity) |
| | common | down | BC043166 | KCNAB1 | potassium voltage- |
| | | | | | gated channel, |
| | | | | | shaker-related |
| | | | | | subfamily, beta |
| | | | | | member 1 |
| | common | down | BC043502 | NEK2 | nima (never in |
| | | | | | mitosis gene a)- |
| | | | | | related kinase 2 |
| | common | down | BC050630 | RAB3-GAP150 | serine/threonine |
| | | | | | kinase 6 |
| | | | | | pseudogene |
| | common | down | BU675073 | PTTG1 | pituitary tumor- |
| | | | | | transforming 1 |
| | common | down | BX640641 | C6orf107 | chromosome 6 open |
| | | | | | reading frame 107 |
| | common | down | CR591317 | LDHA | |
| | common | down | CR604810 | CCNA2 | cyclin a2 |
| | common | down | CR621398 | CDCA3 | cell division |
| | | | | | cycle associated 3 |
| | common | down | CR749832 | IMPDH1 | atpase family, aaa |
| | | | | | domain containing 2 |
| | common | down | CR933728 | CDC2 | cell division |
| | | | | | cycle 2, g1 to s |
| | | | | | and g2 to m |
| | common | down | CR936755 | GBP3 | guanylate binding |
| | | | | | protein 3 |
| | common | down | D79987 | ESPL1 | extra spindle |
| | | | | | poles like 1 (s. cerevisiae) |
| | common | down | M30640 | SELE | selectin e |
| | | | | | (endothelial |
| | | | | | adhesion molecule |
| | | | | | 1) |
| | common | down | NM_001012271 | BIRC5 | baculoviral iap |
| | | | | | repeat-containing |
| | | | | | 5 (survivin) |
| | common | down | NM_001012507 | C6orf173 | |
| | common | down | NM_001254 | CDC6 | cdc6 cell division |
| | | | | | cycle 6 homolog |
| | | | | | (s. cerevisiae) |
| | common | down | NM_001274 | CHEK1 | chk1 checkpoint |
| | | | | | homolog (s. pombe) |
| | common | down | NM_001511 | CXCL1 | chemokine (c—x—c |
| | | | | | motif) ligand 1 |
| | | | | | (melanoma growth |
| | | | | | stimulating |
| | | | | | activity, alpha) |
| | common | down | NM_001773 | CD34 | cd34 antigen |
| | common | down | NM_001789 | CDC25A | cell division |
| | | | | | cycle 25a |
| | common | down | NM_002156 | HSPD1 | |
| | common | down | NM_002994 | CXCL5 | chemokine (c—x—c |
| | | | | | motif) ligand 5 |
| | common | down | NM_003504 | CDC45L | cdc45 cell |
| | | | | | division cycle 45- |
| | | | | | like (s. cerevisiae) |
| | common | down | NM_004111 | FEN1 | flap structure- |
| | | | | | specific |
| | | | | | endonuclease 1 |
| | common | down | NM_004523 | KIF11 | kinesin family |
| | | | | | member 11 |
| | common | down | NM_004701 | CCNB2 | cyclin b2 |
| | common | down | NM_004938 | DAPK1 | death-associated |
| | | | | | protein kinase 1 |
| | common | down | NM_005915 | MCM6 | mcm6 |
| | | | | | minichromosome |
| | | | | | maintenance |
| | | | | | deficient 6 (mis5 |
| | | | | | homolog, s. pombe) |
| | | | | | (s. cerevisiae) |
| | common | down | NM_006716 | ASK | dbf4 homolog (s. cerevisiae) |
| | common | down | NM_006739 | MCM5 | mcm5 |
| | | | | | minichromosome |
| | | | | | maintenance |
| | | | | | deficient 5, cell |
| | | | | | division cycle 46 |
| | | | | | (s. cerevisiae) |
| | common | down | NM_006904 | PRKDC | protein kinase, |
| | | | | | dna-activated, |
| | | | | | catalytic |
| | | | | | polypeptide |
| | common | down | NM_006988 | ADAMTS1 | adam |
| | | | | | metallopeptidase |
| | | | | | with |
| | | | | | thrombospondin |
| | | | | | type 1 motif, 1 |
| | common | down | NM_012415 | RAD54B | fibrinogen |
| | | | | | silencer binding |
| | | | | | protein |
| | common | down | NM_013277 | RACGAP1 | rac gtpase |
| | | | | | activating protein 1 |
| | common | down | NM_014762 | DHCR24 | 24- |
| | | | | | dehydrocholesterol |
| | | | | | reductase |
| | common | down | NM_015254 | KIF13B | kinesin family |
| | | | | | member 13b |
| | common | down | NM_016343 | CENPF | centromere protein |
| | | | | | f, 350/400 ka |
| | | | | | (mitosin) |
| | common | down | NM_016426 | GTSE1 | g-2 and s-phase |
| | | | | | expressed 1 |
| | common | down | NM_020530 | OSM | oncostatin m |
| | common | down | NM_182776 | MCM7 | mcm7 |
| | | | | | minichromosome |
| | | | | | maintenance |
| | | | | | deficient 7 (s. cerevisiae) |
| | common | down | R59856 | CX3CL1 | chemokine (c—x3—c |
| | | | | | motif) ligand 1 |
| | common | down | U18018 | ETV4 | ets variant gene 4 |
| | | | | | (e1a enhancer |
| | | | | | binding protein, |
| | | | | | e1af) |
| | common | down | U65410 | MAD2L1 | mad2 mitotic |
| | | | | | arrest deficient- |
| | | | | | like 1 (yeast) |
| | common | down | W60781 | FABP4 | |

(2 drug: Doxorubicin and Daunorubicin)

TABLE 10
Genes showing changes in expression by the treatment of a
drug causing general toxicity

| GeneBank | Abbreviation | Gene name |
|---|---|---|
| NM_000015 | NAT2 | n-acetyltransferase 2 (arylamine n- |
| | | acetyltransferase) |
| NM_000019 | ACAT1 | acetyl-coenzyme a acetyltransferase |
| | | 1 (acetoacetyl coenzyme a thiolase) |
| NM_000051 | ATM | ataxia telangiectasia mutated |
| | | (includes complementation groups a, |
| | | c and d) |
| NM_000104 | CYP1B1 | cytochrome p450, family 1, subfamily |
| | | b, polypeptide 1 |
| NM_000106 | CYP2D6 | cytochrome p450, family 2, subfamily |
| | | d, polypeptide 6 |
| NM_000120 | EPHX1 | epoxide hydrolase 1, microsomal |
| | | (xenobiotic) |
| NM_000122 | ERCC3 | excision repair cross-complementing |
| | | rodent repair deficiency, |
| | | complementation group 3 (xeroderma |
| | | pigmentosum group b complementing) |
| NM_000240 | MAOA | monoamine oxidase a |
| NM_000367 | TPMT | thiopurine s-methyltransferase |
| NM_000379 | XDH | xanthine dehydrogenase |
| NM_000389 | CDKN1A | cyclin-dependent kinase inhibitor 1a |
| | | (p21, cip1) |
| NM_000392 | ABCC2 | atp-binding cassette, sub-family c |
| | | (cftr/mrp), member 2 |
| NM_000394 | CRYAA | crystallin, alpha a |
| NM_000443 | ABCB4 | atp-binding cassette, sub-family b |
| | | (mdr/tap), member 4 |
| NM_000454 | SOD1 | superoxide dismutase 1, soluble |
| | | (amyotrophic lateral sclerosis 1 |
| | | (adult)) |
| NM_000498 | CYP11B2 | cytochrome p450, family 11, |
| | | subfamily b, polypeptide 2 |
| NM_000499 | CYP1A1 | cytochrome p450, family 1, subfamily |
| | | a, polypeptide 1 |
| NM_000546 | TP53 | tumor protein p53 (li-fraumeni |
| | | syndrome) |
| NM_000581 | GPX1 | glutathione peroxidase 1 |
| NM_000594 | TNF | tumor necrosis factor (tnf |
| | | superfamily, member 2) |
| NM_000595 | LTA | lymphotoxin alpha (tnf superfamily, |
| | | member 1) |
| NM_000636 | SOD2 | superoxide dismutase 2, |
| | | mitochondrial |
| NM_000637 | GSR | glutathione reductase |
| NM_000639 | FASLG | fas ligand (tnf superfamily, member |
| | | 6) |
| NM_000662 | NAT1 | n-acetyltransferase 1 (arylamine n- |
| | | acetyltransferase) |
| NM_000754 | COMT | catechol-o-methyltransferase |
| NM_000755 | Crat | carnitine acetyltransferase |
| NM_000758 | CSF2 | colony stimulating factor 2 |
| | | (granulocyte-macrophage) |
| NM_000761 | CYP1A2 | cytochrome p450, family 1, subfamily |
| | | a, polypeptide 2 |
| NM_000762 | CYP2A6 | cytochrome p450, family 2, subfamily |
| | | a, polypeptide 6 |
| NM_000767 | CYP2B6 | cytochrome p450, family 2, subfamily |
| | | b, polypeptide 6 |
| NM_000770 | CYP2C8 | cytochrome p450, family 2, subfamily |
| | | c, polypeptide 8 |
| NM_000771 | CYP2C9 | cytochrome p450, family 2, subfamily |
| | | c, polypeptide 9 |
| NM_000773 | CYP2E1 | cytochrome p450, family 2, subfamily |
| | | e, polypeptide 1 |
| NM_000774 | CYP2F1 | cytochrome p450, family 2, subfamily |
| | | f, polypeptide 1 |
| NM_000777 | CYP3A5 | cytochrome p450, family 3, subfamily |
| | | a, polypeptide 5 |
| NM_000778 | CYP4A11 | cytochrome p450, family 4, subfamily |
| | | a, polypeptide 11 |
| NM_000779 | CYP4B1 | cytochrome p450, family 4, subfamily |
| | | b, polypeptide 1 |
| NM_000780 | CYP7A1 | cytochrome p450, family 7, subfamily |
| | | a, polypeptide 1 |
| NM_000781 | CYP11A1 | cytochrome p450, family 11, |
| | | subfamily a, polypeptide 1 |
| NM_000782 | CYP24A1 | cytochrome p450, family 24, |
| | | subfamily a, polypeptide 1 |
| NM_000847 | GSTA3 | glutathione s-transferase a3 |
| NM_000848 | GSTM2 | glutathione s-transferase m2 |
| | | (muscle) |
| NM_000849 | GSTM3 | glutathione s-transferase m3 (brain) |
| NM_000851 | GSTM5 | glutathione s-transferase m5 |
| NM_000852 | GSTP1 | glutathione s-transferase pi |
| NM_000853 | GSTT1 | glutathione s-transferase theta 1 |
| NM_000854 | GSTT2 | glutathione s-transferase theta 2 |
| NM_000896 | CYP4F3 | cytochrome p450, family 4, subfamily |
| | | f, polypeptide 3 |
| NM_000898 | MAOB | monoamine oxidase b |
| NM_000927 | ABCB1 | atp-binding cassette, sub-family b |
| | | (mdr/tap), member 1 |
| NM_000940 | PON3 | paraoxonase 3 |
| NM_000941 | POR | p450 (cytochrome) oxidoreductase |
| NM_000962 | PTGS1 | prostaglandin-endoperoxide synthase |
| | | 1 (prostaglandin g/h synthase and |
| | | cyclooxygenase) |
| NM_000963 | PTGS2 | prostaglandin-endoperoxide synthase |
| | | 2 (prostaglandin g/h synthase and |
| | | cyclooxygenase) |
| NM_001055 | SULT1A1 | sulfotransferase family, cytosolic, |
| | | 1a, phenol-preferring, member 1 |
| NM_001056 | SULT1C1 | sulfotransferase family, cytosolic, |
| | | 1c, member 1 |
| NM_001061 | TBXAS1 | thromboxane a synthase 1 (platelet, |
| | | cytochrome p450, family 5, subfamily |
| | | a) |
| NM_001065 | TNFRSF1A | tumor necrosis factor receptor |
| | | superfamily, member 1a |
| NM_001228 | CASP8 | caspase 8, apoptosis-related |
| | | cysteine peptidase |
| NM_001230 | CASP10 | caspase 10, apoptosis-related |
| | | cysteine peptidase |
| NM_001235 | SERPINH1 | serpin peptidase inhibitor, clade h |
| | | (heat shock protein 47), member 1, |
| | | (collagen binding protein 1) |
| NM_001512 | GSTA4 | glutathione s-transferase a4 |
| NM_001539 | DNAJA1 | dnaj (hsp40) homolog, subfamily a, |
| | | member 1 |
| NM_001540 | HSPB1 | heat shock 27 kda protein 1 |
| NM_001562 | IL18 | interleukin 18 (interferon-gamma- |
| | | inducing factor) |
| NM_001565 | CXCL10 | chemokine (c—x—c motif) ligand 10 |
| NM_001609 | ACADSB | acyl-coenzyme a dehydrogenase, |
| | | short/branched chain |
| NM_001746 | CANX | calnexin |
| NM_001752 | CAT | catalase |
| NM_001831 | CLU | clusterin |
| NM_001885 | CRYAB | crystallin, alpha b |
| NM_001924 | GADD45A | growth arrest and dna-damage- |
| | | inducible, alpha |
| NM_001931 | DLAT | dihydrolipoamide s-acetyltransferase |
| | | (e2 component of pyruvate |
| | | dehydrogenase complex) |
| NM_001964 | EGR1 | early growth response 1 |
| NM_001979 | EPHX2 | epoxide hydrolase 2, cytoplasmic |
| NM_001983 | ERCC1 | excision repair cross-complementing |
| | | rodent repair deficiency, |
| | | complementation group 1 (includes |
| | | overlapping antisense sequence) |
| NM_002021 | FMO1 | flavin containing monooxygenase 1 |
| NM_002022 | FMO4 | flavin containing monooxygenase 4 |
| NM_002046 | GAPDH | glyceraldehyde-3-phosphate |
| | | dehydrogenase |
| NM_002083 | GPX2 | glutathione peroxidase 2 |
| | | (gastrointestinal) |
| NM_002133 | HMOX1 | heme oxygenase (decycling) 1 |
| NM_002134 | HMOX2 | heme oxygenase (decycling) 2 |
| NM_002154 | HSPA4 | heat shock 70 kda protein 4 |
| NM_002155 | HSPA6 | heat shock 70 kda protein 6 (hsp70b′) |
| NM_002157 | HSPE1 | heat shock 10 kda protein 1 |
| | | (chaperonin 10) |
| NM_002178 | IGFBP6 | insulin-like growth factor binding |
| | | protein 6 |
| NM_002413 | MGST2 | microsomal glutathione s-transferase 2 |
| NM_002415 | MIF | macrophage migration inhibitory |
| | | factor (glycosylation-inhibiting |
| | | factor) |
| NM_002452 | NUDT1 | nudix (nucleoside diphosphate linked |
| | | moiety x)-type motif 1 |
| NM_002574 | PRDX1 | peroxiredoxin 1 |
| NM_002983 | CCL3 | chemokine (c-c motif) ligand 3 |
| NM_002984 | CCL4 | chemokine (c-c motif) ligand 4 |
| NM_002989 | CCL21 | chemokine (c-c motif) ligand 21 |
| NM_003167 | SULT2A1 | sulfotransferase family, cytosolic, |
| | | 2a, dehydroepiandrosterone (dhea)- |
| | | preferring, member 1 |
| NM_003299 | TRA1 | heat shock protein 90 kda beta |
| | | (grp94), member 1 |
| NM_003315 | DNAJC7 | dnaj (hsp40) homolog, subfamily c, |
| | | member 7 |
| NM_003595 | TPST2 | tyrosylprotein sulfotransferase 2 |
| NM_003596 | TPST1 | tyrosylprotein sulfotransferase 1 |
| NM_003642 | HAT1 | histone acetyltransferase 1 |
| NM_003654 | CHST1 | carbohydrate (keratan sulfate gal-6) |
| | | sulfotransferase 1 |
| NM_003786 | ABCC3 | atp-binding cassette, sub-family c |
| | | (cftr/mrp), member 3 |
| NM_003789 | TRADD | tnfrsf1a-associated via death domain |
| NM_003810 | TNFSF10 | tumor necrosis factor (ligand) |
| | | superfamily, member 10 |
| NM_003932 | ST13 | suppression of tumorigenicity 13 |
| | | (colon carcinoma) (hsp70 interacting |
| | | protein) |
| NM_003998 | NFKB1 | nuclear factor of kappa light |
| | | polypeptide gene enhancer in b-cells |
| | | 1 (p105) |
| NM_004048 | B2M | beta-2-microglobulin |
| NM_004050 | BCL2L2 | bcl2-like 2 |
| NM_004060 | CCNG1 | cyclin g1 |
| NM_004083 | DDIT3 | dna-damage-inducible transcript 3 |
| NM_004134 | HSPA9B | heat shock 70 kda protein 9b |
| | | (mortalin-2) |
| NM_004267 | CHST2 | carbohydrate (n-acetylglucosamine-6- |
| | | o) sulfotransferase 2 |
| NM_004273 | CHST3 | carbohydrate (chondroitin 6) |
| | | sulfotransferase 3 |
| NM_004323 | BAG1 | bcl2-associated athanogene |
| NM_004324 | BAX | bcl2-associated x protein |
| NM_004343 | CALR | calreticulin |
| NM_004391 | CYP8B1 | cytochrome p450, family 8, subfamily |
| | | b, polypeptide 1 |
| NM_004528 | MGST3 | microsomal glutathione s-transferase 3 |
| NM_004605 | SULT2B1 | sulfotransferase family, cytosolic, |
| | | 2b, member 1 |
| NM_004820 | CYP7B1 | cytochrome p450, family 7, subfamily |
| | | b, polypeptide 1 |
| NM_004827 | ABCG2 | atp-binding cassette, sub-family g |
| | | (white), member 2 |
| NM_004832 | GSTO1 | glutathione s-transferase omega 1 |
| NM_004854 | CHST10 | carbohydrate sulfotransferase 10 |
| NM_004861 | GAL3ST1 | galactose-3-o-sulfotransferase 1 |
| NM_004996 | ABCC1 | atp-binding cassette, sub-family c |
| | | (cftr/mrp), member 1 |
| NM_005053 | RAD23A | rad23 homolog a (s. cerevisiae) |
| NM_005147 | DNAJA3 | dnaj (hsp40) homolog, subfamily a, |
| | | member 3 |
| NM_005190 | CCNC | cyclin c |
| NM_005225 | E2F1 | e2f transcription factor 1 |
| NM_005345 | HSPA1A | heat shock 70 kda protein 1a |
| NM_005347 | HSPA5 | heat shock 70 kda protein 5 (glucose- |
| | | regulated protein, 78 kda) |
| NM_005348 | HSPCA | heat shock protein 90 kda alpha |
| | | (cytosolic), class a member 1 |
| NM_005420 | SULT1E1 | sulfotransferase family 1e, |
| | | estrogen-preferring, member 1 |
| NM_005431 | XRCC2 | x-ray repair complementing defective |
| | | repair in chinese hamster cells 2 |
| NM_005526 | HSF1 | heat shock transcription factor 1 |
| NM_005527 | HSPA1L | heat shock 70 kda protein 1-like |
| NM_005528 | DNAJC4 | dnaj (hsp40) homolog, subfamily c, |
| | | member 4 |
| NM_005688 | ABCC5 | atp-binding cassette, sub-family c |
| | | (cftr/mrp), member 5 |
| NM_005732 | RAD50 | rad50 homolog (s. cerevisiae) |
| NM_005769 | CHST4 | carbohydrate (n-acetylglucosamine 6- |
| | | o) sulfotransferase 4 |
| NM_005809 | PRDX2 | peroxiredoxin 2 |
| NM_005880 | DNAJA2 | dnaj (hsp40) homolog, subfamily a, |
| | | member 2 |
| NM_005952 | MT1X | metallothionein 1x |
| NM_005953 | MT2A | metallothionein 2a |
| NM_005954 | MT3 | metallothionein 3 (growth inhibitory |
| | | factor (neurotrophic)) |
| NM_005998 | CCT3 | chaperonin containing tcp1, subunit |
| | | 3 (gamma) |
| NM_006145 | DNAJB1 | dnaj (hsp40) homolog, subfamily b, |
| | | member 1 |
| NM_006169 | NNMT | nicotinamide n-methyltransferase |
| NM_006308 | HSPB3 | heat shock 27 kda protein 3 |
| NM_006389 | HYOU1 | hypoxia up-regulated 1 |
| NM_006429 | CCT7 | chaperonin containing tcp1, subunit |
| | | 7 (eta) |
| NM_006430 | CCT4 | chaperonin containing tcp1, subunit |
| | | 4 (delta) |
| NM_006431 | CCT2 | chaperonin containing tcp1, subunit |
| | | 2 (beta) |
| NM_006585 | CCT8 | chaperonin containing tcp1, subunit |
| | | 8 (theta) |
| NM_006588 | SULT1C2 | sulfotransferase family, cytosolic, |
| | | 1c, member 2 |
| NM_006597 | HSPA8 | heat shock 70 kda protein 8 |
| NM_006644 | HSPH1 | heat shock 105 kda/110 kda protein 1 |
| NM_006736 | DNAJB2 | dnaj (hsp40) homolog, subfamily b, |
| | | member 2 |
| NM_006895 | HNMT | histamine n-methyltransferase |
| NM_007034 | DNAJB4 | dnaj (hsp40) homolog, subfamily b, |
| | | member 4 |
| NM_007067 | MYST2 | myst histone acetyltransferase 2 |
| NM_007194 | CHEK2 | chk2 checkpoint homolog (s. pombe) |
| NM_007326 | DIA1 | cytochrome b5 reductase 3 |
| NM_007355 | HSPCB | heat shock protein 90 kda alpha |
| | | (cytosolic), class b member 1 |
| NM_012073 | CCT5 | chaperonin containing tcp1, subunit |
| | | 5 (epsilon) |
| NM_012126 | CHST5 | carbohydrate (n-acetylglucosamine 6- |
| | | o) sulfotransferase 5 |
| NM_012266 | DNAJB5 | dnaj (hsp40) homolog, subfamily b, |
| | | member 5 |
| NM_012328 | DNAJB9 | dnaj (hsp40) homolog, subfamily b, |
| | | member 9 |
| NM_012330 | MYST4 | myst histone acetyltransferase |
| | | (monocytic leukemia) 4 |
| NM_012423 | RPL13A | ribosomal protein 113a |
| NM_014280 | DNAJC8 | dnaj (hsp40) homolog, subfamily c, |
| | | member 8 |
| NM_014351 | SULT4A1 | sulfotransferase family 4a, member 1 |
| NM_014465 | SULT1B1 | sulfotransferase family, cytosolic, |
| | | 1b, member 1 |
| NM_015675 | GADD45B | growth arrest and dna-damage- |
| | | inducible, beta |
| NM_016100 | NAT5 | n-acetyltransferase 5 (ard1 homolog, |
| | | s. cerevisiae) |
| NM_016280 | CES4 | carboxylesterase 4-like |
| NM_016306 | DNAJB11 | dnaj (hsp40) homolog, subfamily b, |
| | | member 11 |
| NM_017460 | CYP3A4 | cytochrome p450, subfamily iiia |
| | | (niphedipine oxidase), polypeptide 3 |
| NM_018602 | DNAJA4 | dnaj (hsp40) homolog, subfamily a, |
| | | member 4 |
| NM_019885 | CYP26B1 | cytochrome p450, family 26, |
| | | subfamily b, polypeptide 1 |
| NM_019886 | CHST7 | carbohydrate (n-acetylglucosamine 6- |
| | | o) sulfotransferase 7 |
| NM_020300 | MGST1 | microsomal glutathione s-transferase 1 |
| NM_020529 | NFKBIA | nuclear factor of kappa light |
| | | polypeptide gene enhancer in b-cells |
| | | inhibitor, alpha |
| NM_020674 | CYP20A1 | cytochrome p450, family 20, |
| | | subfamily a, polypeptide 1 |
| NM_020985 | CHAT | choline acetyltransferase |
| NM_021130 | PPIA | peptidylprolyl isomerase a |
| | | (cyclophilin a) |
| NM_021615 | CHST6 | carbohydrate (n-acetylglucosamine 6- |
| | | o) sulfotransferase 6 |
| NM_021979 | HSPA2 | heat shock 70 kda protein 2 |
| NM_022467 | CHST8 | carbohydrate (n-acetylgalactosamine |
| | | 4-0) sulfotransferase 8 |
| NM_025219 | DNAJC5 | dnaj (hsp40) homolog, subfamily c, |
| | | member 5 |
| NM_030752 | TCP1 | t-complex 1 |
| NM_033292 | CASP1 | caspase 1, apoptosis-related |
| | | cysteine peptidase (interleukin 1, |
| | | beta, convertase) |
| NM_053056 | CCND1 | cyclin d1 |
| NM_138578 | BCL2L1 | bcl2-like 1 |
| NM_139211 | HOP | homeodomain-only protein |
| NM_182649 | PCNA | proliferating cell nuclear antigen |

### EXAMPLE 3

### Construction of Toxtarget Array

### <3-1> Oligomer Design and Synthesis of Toxicity/Side-Effect Related Genes

To construct Toxtarget Array, 512 kinds of oligomers of those toxicity/side-effect related genes selected in <Example 2> were required, so that they were purchased from Agilent Technologies by comparing oligomer set list thereof.

### <3-1> Construction of Toxtarget Array

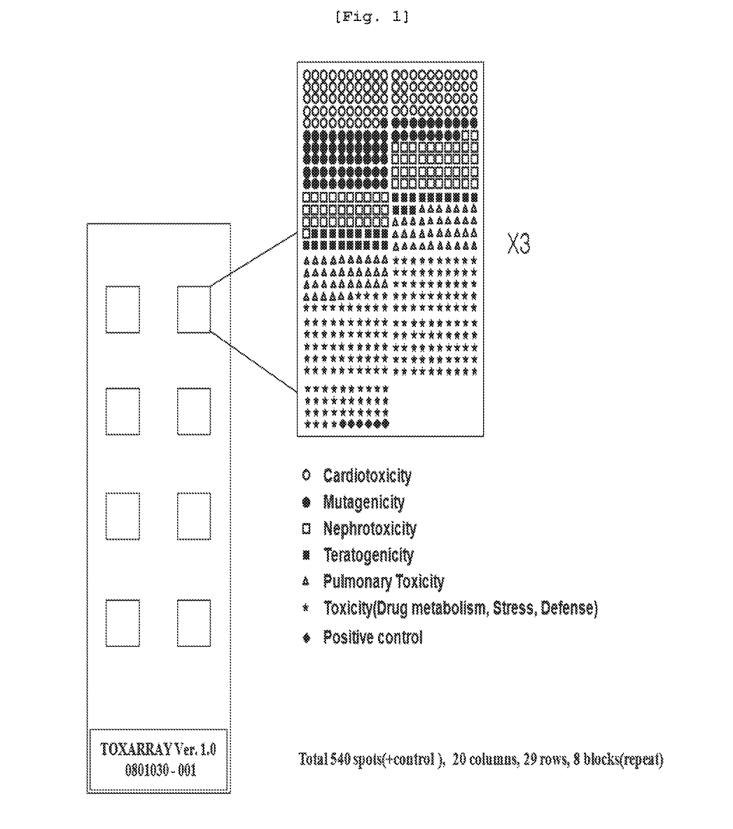

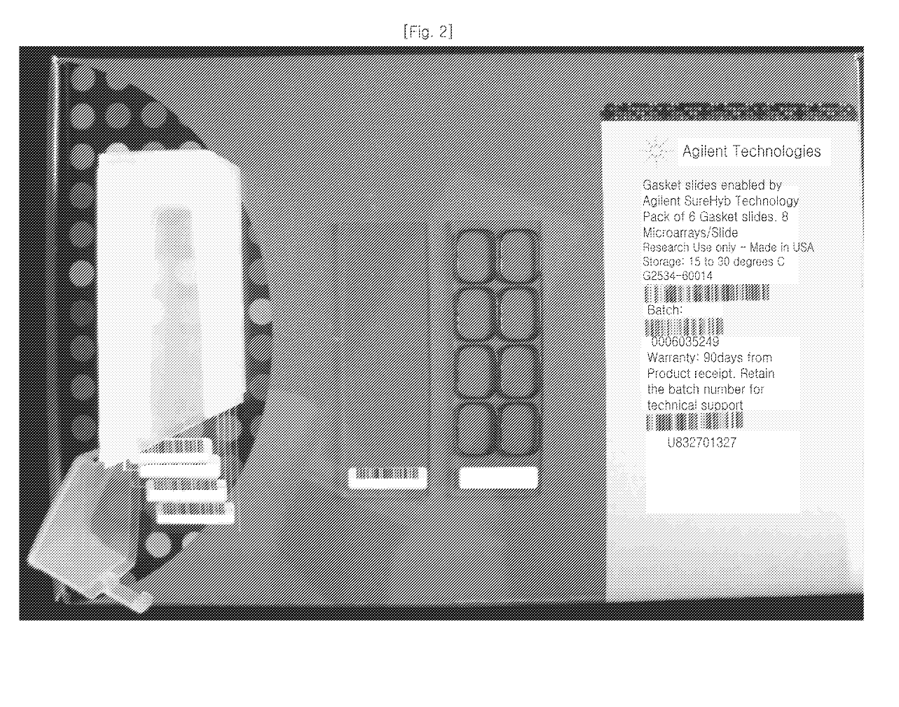

For convenience in preparing prototype, microarray construction service of Agilent technologies was used. Probe design with 512 genes in total was requested and probes were prepared in 60 mer uniform type. Array format was as follows; 512 probes were chipped on 1×3 inch glass slide three times repetedly, resulting in 8 plex type, suggesting that this format facilitates 8 tests at a time (FIGS. 1 and 2).

### EXAMPLE 4

### Toxtarget Array Verification Test

Toxtarget array verification test was performed with the conventional and additionally selected materials.

### <4-1> Cytotoxicity Test (MTT Assay) and Chemical Treatment

MTT assay was performed with BEAS-2B, JEG-3, HK-2 and HepG2 according to the method of Mossman et al (J. Immunol. Methods, 65, 55-63, 1983). The cells (Table 2) in a 24-well plate were treated with each drug dissolved in DMSO or water. 24 and 48 hours later, 5 mg/μl of MTT (3-[4,5-dimethylthiazol-2-yl]-2,5-diphenyltetra zolium bromide) was added thereto, followed by culture at 37 for 3 hours. Then, the medium was eliminated and the formed formazan crystal was dissolved in 500 μl of DMSO. The mixture was aliquoted in a 96-well plate and OD₅₄₀ was measured. Cytotoxicity of additional 7 drugs in each cell line was measured and the results are as shown in Table 11.

TABLE 11

| | Cell line | | | | | |
|---|---|---|---|---|---|---|
| | and cell | | Treatment | | | |
| Toxicity | number | Drug | time | Cytotoxicity | Conc. | |
| pulmonary | BEAS-2B; | Amiodarone | 48 h | IC20 | 29.388 | uM |
| toxicity | 3 × 10⁴ | | | | | |
| | cells/well | | | | | |
| teratogenicity | JEG-3; | Thalidomide | 48 h | IC30 | 4.283 | mM |
| | 3 × 10⁴ | Warfarin | | | 8.16 | mM |
| | cells/well | | | | | |
| nephrotoxicity | HK-2; | Neomycin | 24 h | IC30 | 14.7 | mg/ml |
| | 2.3 × 10⁴ | Ibuprofen | | | 1.65 | mg/ml |
| | cells/well | | | | | |
| General | HepG2; | Benzo(a)pyrene | 48 h | IC20 | 8.35 | uM |
| toxicity | 40 × 10⁴ | Acetaminophene | | | 11 | mM |
| | cells/well | | | | | |

(IC20, concentration at which survival is inhibited 20%; IC30, concentration at which survival is inhibited 30%)

Microarray was performed by the same manner as described in <Example 2> using Toxtarget Array prepared above at the concentration determined above.

### <4-2> Selection of Toxicity Type-Specific Gene

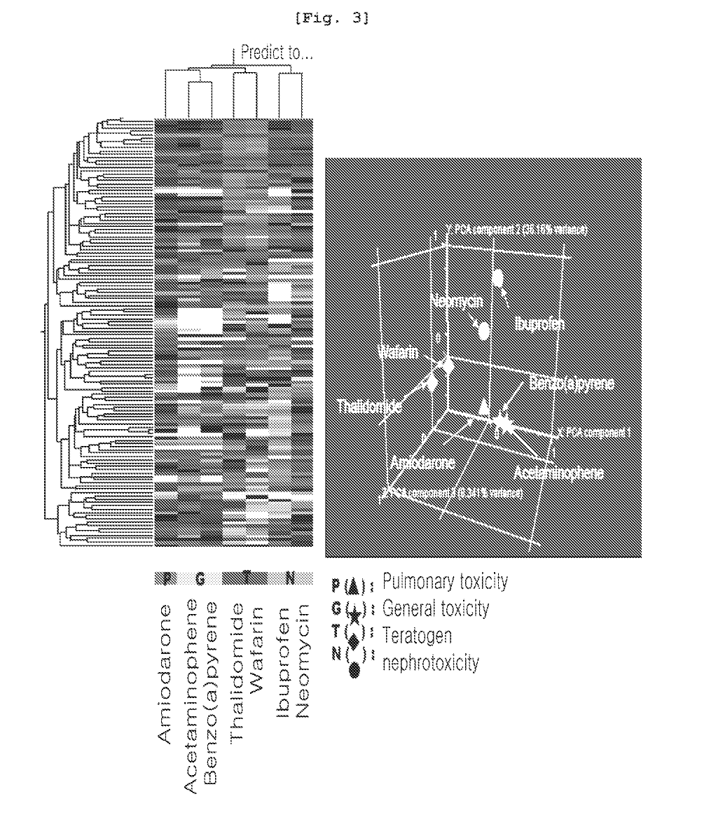

The conventional and additionally selected drugs were applied to Toxtarget Array. The result was analyzed with GeneSpring GX version 7.3 software (Agilent Technologies), and as a result each toxicity type-specific genes were selected. Particularly, “k-Nearest neighbors” algorithm was used. Gene selection was performed by “Golub method” (Neighbors gene number: 4, cut-off p-value ratio: 0.5). As a result, 75 out of 512 genes loaded in Toxtarget Array were confirmed to be toxicity type-specific genes. Those genes were confirmed again to be toxicity type-specific genes by Hierarchical Clustering Analysis and Principal Component Analysis (FIG. 3). 75 kinds of genes are as follows:

1) Marker Genes Showing Changes in Expression by the Treatment of a Drug Causing Pulmonary Toxicity:

GenBank AF289615 (hypothetical protein), GenBank NM_{—}000575 (interleukin 1, alpha), GenBank NM_{—}001001958 (olfactory receptor, family 7, subfamily g, member 3), GenBank NM_{—}001295 [chemokine (c-c motif) receptor 1], GenBank NM_{—}002305 [lectin, galactoside-binding, soluble, 1 (galectin 1)], GenBank NM_{—}004293 (guanine deaminase), GenBank NM_{—}030754 (serum amyloid a2).

2) Marker Genes Showing Changes in Expression by the Treatment of a Drug Causing Teratogenicity:

GenBank NM_{—}000735 (glycoprotein hormones, alpha polypeptide), GenBank NM_{—}004155 [serpin peptidase inhibitor, clade b (ovalbumin), member 9], GenBank NM_{—}005668 (st8 alpha-n-acetyl-neuraminide alpha-2,8-sialyltransferase 4), GenBank NM_{—}032484 (homolog of mouse lgp1).

3) Marker Genes Showing Changes in Expression by the Treatment of a Drug Causing Nephrotoxicity:

GenBank NM_{—}000134 (fatty acid binding protein 2, intestinal), GenBank NM_{—}005203 (collagen, type xiii, alpha 1), GenBank NM_{—}015946 (pro1770 protein), GenBank NM_{—}138417 [kti12 homolog, chromatin associated (s. cerevisiae)], GenBank NM_{—}145202 (proline-rich acidic protein 1), GenBank NM_{—}173160(fxyd domain containing ion transport regulator 4).

4) Marker Genes Showing Changes in Expression by the Treatment of a Drug Causing Mutation:

GenBank NM_{—}000715 (complement component 4 binding protein, alpha), GenBank NM_{—}001141 (arachidonate 15-lipoxygenase, type b), GenBank NM_{—}001711 (biglycan), GenBank NM_{—}001974 (egf-like module containing, mucin-like, hormone receptor-like 1), GenBank NM_{—}003722 (tumor protein p73-like), GenBank NM_{—}005510 [dom-3 homolog z (c. elegans)], GenBank NM_{—}007267 (transmembrane channel-like 6).

5) Marker Genes Showing Changes in Expression by the Treatment of a Drug Causing Cardiotoxicity:

GenBank NM_{—}012415 (fibrinogen silencer binding protein), GenBank NM_{—}021101 (claudin 1).

6) Marker Genes Showing Changes in Expression by the Treatment of a Drug Causing General Toxicity:

GenBank NM_{—}000051[ataxia telangiectasia mutated(includes complementation groups a, c and d)], GenBank NM_{—}000104(cytochrome p450, family 1, subfamily b, polypeptide 1), GenBank NM_{—}000120[epoxide hydrolase 1, microsomal(xenobiotic)], GenBank NM_{—}000240(monoamine oxidase a), GenBank NM_{—}000546[tumor protein p53(li-fraumeni syndrome)], GenBank NM_{—}000639[fas ligand(tnf superfamily, member 6)], GenBank NM_{—}000762(cytochrome p450, family 2, subfamily a, polypeptide 6), GenBank NM_{—}000771(cytochrome p450, family 2, subfamily c, polypeptide 9), GenBank NM_{—}000773(cytochrome p450, family 2, subfamily e, polypeptide 1), GenBank NM_{—}000780(cytochrome p450, family 7, subfamily a, polypeptide 1), GenBank NM_{—}000847(glutathione s-transferase a3), GenBank NM_{—}000851(glutathione s-transferase m5), GenBank NM_{—}000927[atp-binding cassette, sub-family b(mdr/tap), member 1], GenBank NM_{—}000940(paraoxonase 3), GenBank NM_{—}000962[prostaglandin-endoperoxide synthase 1(prostaglandin g/h synthase and cyclooxygenase)], GenBank NM_{—}001540(heat shock 27 kda protein 1), GenBank NM_{—}001565[chemokine(c-x-c motif) ligand 10], GenBank NM_{—}001746(calnexin), GenBank NM_{—}001752(catalase), GenBank NM_{—}001885(crystallin, alpha b), GenBank NM_{—}001979(epoxide hydrolase 2, cytoplasmic), GenBank NM_{—}002021(flavin containing monooxygenase 1), GenBank NM_{—}002083[glutathione peroxidase 2(gastrointestinal)], GenBank NM_{—}002155[heat shock 70 kda protein 6(hsp70b′)], GenBank NM_{—}003167[sulfotransferase family, cytosolic, 2a, dehydroepiandrosterone(dhea)-preferring, member 1], GenBank NM_{—}003786[atp-binding cassette, sub-family c(cftr/mrp), member 3], GenBank NM_{—}003932[suppression of tumorigenicity 13(colon carcinoma)(hsp70 interacting protein)], GenBank NM_{—}004050(bcl2-like 2), GenBank NM_{—}004083(dna-damage-inducible transcript 3), GenBank NM_{—}004323(bcl2-associated athanogene), GenBank NM_{—}004343(calreticulin), GenBank NM_{—}004605(sulfotransferase family, cytosolic, 2b, member 1), GenBank NM_{—}004820(cytochrome p450, family 7, subfamily b, polypeptide 1), GenBank NM_{—}004832(glutathione s-transferase omega 1), GenBank NM_{—}005420(sulfotransferase family 1e, estrogen-preferring, member 1), GenBank NM_{—}005431(x-ray repair complementing defective repair in chinese hamster cells 2), GenBank NM_{—}005953(metallothionein 2a), GenBank NM_{—}006308(heat shock 27 kda protein 3), GenBank NM_{—}006431[chaperonin containing tcpl, subunit 2(beta)], GenBank NM_{—}006588(sulfotransferase family, cytosolic, 1c, member 2), GenBank NM_{—}007326(cytochrome b5 reductase 3), GenBank NM_{—}012266[dnaj(hsp40) homolog, subfamily b, member 5], GenBank NM_{—}014280[dnaj(hsp40) homolog, subfamily c, member 8], GenBank NM_{—}016100[n-acetyltransferase 5(ard1 homolog, s. cerevisiae)], GenBank NM_{—}017460[cytochrome p450, subfamily iiia(niphedipine oxidase), polypeptide 3], GenBank NM_{—}018602[dnaj(hsp40) homolog, subfamily a, member 4], GenBank NM_{—}021979(heat shock 70 kda protein 2), GenBank NM_{—}033292[caspase 1, apoptosis-related cysteine peptidase(interleukin 1, beta, convertase)], GenBank NM_{—}053056(cyclin d1).

### INDUSTRIAL APPLICABILITY

As explained hereinbefore, Toxtarget Array of the present invention is very useful for monitoring novel drugs or chemicals carrying toxicity to human or determining risks thereof and also it can be used as a tool for examining mechanisms of target organ specific toxicity/side effects caused by the drugs.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended Claims.

What is claimed is:

1. A DNA microarray for screening a drug inducing toxicity in human, on which oligonucleotides comprising whole nucleic acid sequence or 18-30 nucleic acids of those genes selected among group 1)-group 6) or their complementary sequences are integrated:
Group 1) one or more genes selected from the following gene group showing changes in expression specifically by the treatment of a drug causing pulmonary toxicity:
GenBank AF289615 (hypothetical protein), GenBank NM_{—}000575 (interleukin 1, alpha), GenBank NM_{—}001001958 (olfactory receptor, family 7, subfamily g, member 3), GenBank NM_{—}001295 [chemokine(c-c motif) receptor 1], GenBank NM_{—}002305 [lectin, galactoside-binding, soluble, (galectin 1)], GenBank NM_{—}004293 (guanine deaminase), GenBank NM_{—}030754 (serum amyloid a2);
Group 2) one or more genes selected from the following gene group showing changes in expression specifically by the treatment of a drug causing teratogenicity:
GenBank NM_{—}000735 (glycoprotein hormones, alpha polypeptide), GenBank NM_{—}004155 [serpin peptidase inhibitor, clade b (ovalbumin), member 9], GenBank NM_{—}005668 (st8 alpha-n-acetyl-neuraminide alpha-2,8-sialyltransferase 4), GenBank NM_{—}032484 (homolog of mouse lgp1);
Group 3) one or more genes selected from the following gene group showing changes in expression specifically by the treatment of a drug causing nephrotoxicity:
GenBank NM_{—}000134 (fatty acid binding protein 2, intestinal), GenBank NM_{—}005203 (collagen, type xiii, alpha 1), GenBank NM_{—}015946 (pro1770 protein), GenBank NM_{—}138417 [kti12 homolog, chromatin associated (s. cerevisiae)], GenBank NM_{—}145202 (proline-rich acidic protein 1), GenBank NM_{—}173160 (fxyd domain containing ion transport regulator 4);
Group 4) one or more genes selected from the following gene group showing changes in expression specifically by the treatment of a drug causing mutation:
GenBank NM_{—}000715 (complement component 4 binding protein, alpha), GenBank NM_{—}001141 (arachidonate 15-lipoxygenase, type b), GenBank NM_{—}001711 (biglycan), GenBank NM_{—}001974 (egf-like module containing, mucin-like, hormone receptor-like 1), GenBank NM_{—}003722 (tumor protein p73-like), GenBank NM_{—}005510 [dom-3 homolog z (c. elegans)], GenBank NM_{—}007267 (transmembrane channel-like 6);
Group 5) one or more genes selected from the following gene group showing changes in expression specifically by the treatment of a drug causing cardiotoxicity:
GenBank NM_{—}012415 (fibrinogen silencer binding protein), GenBank NM_{—}021101 (claudin 1); and
Group 6) one or more genes selected from the following gene group showing changes in expression specifically by the treatment of a drug causing general toxicity:
GenBank NM_{—}000051 [ataxia telangiectasia mutated (includes complementation groups a, c and d)], GenBank NM_{—}000104 (cytochrome p450, family 1, subfamily b, polypeptide 1), GenBank NM_{—}000120 [epoxide hydrolase 1, microsomal (xenobiotic)], GenBank NM_{—}000240 (monoamine oxidase a), GenBank NM_{—}000546 [tumor protein p53 (li-fraumeni syndrome)], GenBank NM_{—}000639 [fas ligand (tnf superfamily, member 6)], GenBank NM_{—}000762 (cytochrome p450, family 2, subfamily a, polypeptide 6), GenBank NM_{—}000771 (cytochrome p450, family 2, subfamily c, polypeptide 9), GenBank NM_{—}000773 (cytochrome p450, family 2, subfamily e, polypeptide 1), GenBank NM_{—}000780 (cytochrome p450, family 7, subfamily a, polypeptide 1), GenBank NM_{—}000847 (glutathione s-transferase a3), GenBank NM_{—}000851 (glutathione s-transferase m5), GenBank NM_{—}000927 [atp-binding cassette, sub-family b (mdr/tap), member 1], GenBank NM_{—}000940 (paraoxonase 3), GenBank NM_{—}000962 [prostaglandin-endoperoxide synthase 1 (prostaglandin g/h synthase and cyclooxygenase)], GenBank NM_{—}001540 (heat shock 27 kda protein 1), GenBank NM_{—}001565 [chemokine (c-x-c motif) ligand 10], GenBank NM_{—}001746 (calnexin), GenBank NM_{—}001752 (catalase), GenBank NM_{—}001885 (crystallin, alpha b), GenBank NM_{—}001979 (epoxide hydrolase 2, cytoplasmic), GenBank NM_{—}002021 (flavin containing monooxygenase 1), GenBank NM_{—}002083 [glutathione peroxidase 2 (gastrointestinal)], GenBank NM_{—}002155 [heat shock 70 kda protein 6 (hsp70b′)], GenBank NM_{—}003167 [sulfotransferase family, cytosolic, 2a, dehydroepiandrosterone(dhea)-preferring, member 1], GenBank NM_{—}003786 [atp-binding cassette, sub-family c (cftr/mrp), member 3], GenBank NM_{—}003932 [suppression of tumorigenicity 13 (colon carcinoma) (hsp70 interacting protein)], GenBank NM_{—}004050 (bcl2-like 2), GenBank NM_{—}004083 (dna-damage-inducible transcript 3), GenBank NM_{—}004323 (bcl2-associated athanogene), GenBank NM_{—}004343 (calreticulin), GenBank NM_{—}004605 (sulfotransferase family, cytosolic, 2b, member 1), GenBank NM_{—}004820 (cytochrome p450, family 7, subfamily b, polypeptide 1), GenBank NM_{—}004832 (glutathione s-transferase omega 1), GenBank NM_{—}005420 (sulfotransferase family le, estrogen-preferring, member 1), GenBank NM_{—}005431 (x-ray repair complementing defective repair in Chinese hamster cells 2), GenBank NM_{—}005953 (metallothionein 2a), GenBank NM_{—}006308 (heat shock 27 kda protein 3), GenBank NM_{—}006431 [chaperonin containing tcpl, subunit 2 (beta)], GenBank NM_{—}006588 (sulfotransferase family, cytosolic, lc, member 2), GenBank NM_{—}007326 (cytochrome b5 reductase 3), GenBank NM_{—}012266 [dnaj (hsp40) homolog, subfamily b, member 5], GenBank NM_{—}014280 [dnaj (hsp40) homolog, subfamily c, member 8], GenBank NM_{—}016100 [n-acetyltransferase 5 (ard1 homolog, s. cerevisiae)], GenBank NM_{—}017460 [cytochrome p450, subfamily iiia (niphedipine oxidase), polypeptide 3], GenBank NM_{—}018602 [dnaj (hsp40) homolog, subfamily a, member 4], GenBank NM_{—}021979 (heat shock 70 kda protein 2), GenBank NM_{—}033292 [caspase 1, apoptosis-related cysteine peptidase (interleukin 1, beta, convertase)], GenBank NM_{—}053056 (cyclin d1).

2. The DNA microarray according to claim 1, wherein the drug inducing toxicity in human is one or more compounds selected from the group consisting of pulmonary toxicity inducing drugs, teratogenicity inducing drugs, nephrotoxicity inducing drugs, mutation inducing drugs and cardiotoxicity inducing drugs.

3. The DNA microarray according to claim 1, wherein the drug inducing toxicity in human is one or more compounds selected from the group consisting of Methotrexate, Nitrofurantoin, Amiodarone, Carbamazepine, Valproic acid, Thalidomide, Cisplatin, Gentamycin, Amphotericine, Furylfuramide (AF-2), N-nitroso-N-methylurea (MNU), methylmethanesulfonate (MMS), 4-nitroquinoline-N-oxide (4-NQO), 2-nitrofluorene (2NF), Doxorubicin and Daunorubicin.

4. A screening method of a drug causing toxicity in human comprising the following steps:
1) treating a sample compound to a human cell line;
2) extracting RNA from the experimental group cells treated with the sample compound of step 1) and from the control group cells not treated with the sample compound;
3) labeling the experimental group cDNA and the control group cDNA with different fluoresceins while synthesizing cDNA from the RNA extracted from the experimental and control groups;
4) hybridizing the cDNA of step 3) each labeled with different fluoresceins with the DNA microarray of the present invention;
5) analyzing the reacted DNA microarray; and
6) comparing the expression patterns of genes integrated on the DNA microarray of claim 1 with that of the control based on the data analyzed in step 5).

5. The screening method according to claim 4, wherein the human cell line of step 1) is selected from the group consisting of BEAS-2B, JEG-3, HK-2, THLE-3 and HUVEC.

6. The screening method according to claim 4, wherein the fluorescein of step 3) is selected from the group consisting of Cy3, Cy5, poly L-lysine-fluorescein isothiocyanate (FITC), rhodamine-B-isothiocyanate (RITC) and rhodamine.

7. A kit for screening a drug inducing toxicity in human containing the DNA microarray of claim 1.

8. The kit according to claim 7, wherein the kit additionally includes one or more human cell lines selected from the group consisting of BEAS-2B, JEG-3, HK-2, THLE-3 and HUVEC.

9. The kit according to claim 7, wherein the kit additionally includes a fluorescein selected from the group consisting of streptavidin-like phosphatase conjugate, chemiflurorensce and chemiluminescent.

10. The kit according to claim 7, wherein the kit additionally includes a reaction reagent selected from the group consisting of buffer for hybridization, reverse transcriptase to synthesize cDNA from RNA, cNTPs and rNTP (pre-mix or separated), labeling reagent and washing buffer.
